(19) United States
(12) Patent Application Publication
(10) Pub. No.: US 2023/0116424 A1
(43) Pub. Date: Apr. 13, 2023

(54) CORE-SHEATH FILAMENTS WITH A CURABLE COMPOSITION IN THE CORE

(71) Applicant: 3M INNOVATIVE PROPERTIES COMPANY, St. Paul, MN (US)

(72) Inventors: Kathleen S. Shafer, Woodbury, MN (US); Thomas Q. Chastek, St. Paul, MN (US); Mark E. Napierala, St. Paul, MN (US); Jacob D. Young, St. Paul, MN (US); Ross E. Behling, Woodbury, MN (US); Shaun M. West, St. Paul, MN (US); John Christopher Thomas, St. Paul, MN (US)

(21) Appl. No.: 17/904,877

(22) PCT Filed: Mar. 16, 2021
(86) PCT No.: PCT/IB2021/052191

§ 371 Date: Aug. 24, 2022

Related U.S. Application Data
(60) Provisional application No. 63/002,477, filed on Mar. 31, 2020.

(51) Int. Cl. D01D 5/34; B29C 64/118; D01F 8/16; C09J 163/00

(52) U.S. Cl. CPC D01D 5/34; B29C 64/118; D01F 8/16; C09J 163/00; C09J 2301/202

(57) ABSTRACT

A core-sheath filament is provided that includes a curable composition. The curable composition contains an epoxy resin and a photoacid generator. Methods of making the core-sheath filament and methods of using the core-sheath filament for printing and bonding are provided. The core-sheath filaments can be used to form a cured composition having structural bonding performance.

### BACKGROUND

The use of fused filament fabrication (FFF) to produce three-dimensional articles has been known for a relatively long time, and these processes are generally known as methods of so-called 3D printing (or additive manufacturing). In FFF, a plastic filament is melted in a moving printhead to form a printed article in a layer-by-layer, additive manner. The filaments are often composed of polylactic acid, nylon, polyethylene terephthalate (typically glycol-modified), or acrylonitrile butadiene styrene.

Various curable compositions containing an epoxy resin are known and have been used for bonding various surfaces together. For example, the curable compositions can be used to form structural bonds between surfaces.

### SUMMARY

A core-sheath filament is provided that includes a curable composition. The curable composition contains an epoxy resin and a photoacid generator. Methods of making the filament and methods of using the filament for printing and bonding are provided. The filaments can be used to form a cured composition having structural bonding performance.

In a first aspect, a core-sheath filament is provided. The core-sheath filament has a core that contains a curable composition that includes 1) an epoxy resin and 2) a photoacid generator. A sheath surrounds the core and contains a thermoplastic material that is non-tacky.

In a second aspect, a method of making a core-sheath filament is provided. The method includes forming (or providing) a core that is curable composition containing 1) an epoxy resin and 2) a photoacid generator. The method further includes providing a sheath that contains a non-tacky thermoplastic material. The method still further includes surrounding the core with the sheath to form the core-sheath filament.

In a third aspect, a method of printing and bonding is provided. The method includes providing a core-sheath filament as described in the first aspect above. The method further includes melting the core-sheath filament and blending the sheath with the core to form a blended filament composition. The method still further includes dispensing the blended filament composition through a nozzle onto at least a first portion of a first substrate. The method yet further includes positioning either a second substrate or a second portion of the first substrate in contact with the blended filament composition before or after exposing the blended filament composition to ultraviolet and/or visible radiation to activate curing of the curable composition. The method still further includes forming a structural adhesive bond between at least the first portion of the first substrate and either and the second substrate or the second portion of the first substrate.

### BRIEF DESCRIPTION OF THE DRAWINGS

FIG. 1 is a schematic perspective exploded view of a section of an exemplary core-sheath filament.

FIG. 2 is a schematic cross-sectional view of an exemplary core-sheath filament.

### DETAILED DESCRIPTION

A core-sheath filament is provided that contains a core and a non-tacky sheath surrounding the core. The core contains a curable composition that includes an epoxy resin and a photoacid generator. The core-sheath filament can be heated and mixed to form a blended filament composition that can be dispensed onto at least a first portion of a first substrate. Either a second substrate or a second portion of the first substrate can be positioned in contact with the blended filament composition before or after exposing the blended filament composition to ultraviolet and/or visible radiation to activate curing of the curable composition. The method still further includes forming a cured composition between at least the first portion of the first substrate and either the second substrate or the second portion of the first substrate. The substrates (i.e., either the first substrate and second substrate or the first portion of the first substrate and the second portion of the first substrate) can have a variety of sizes and shapes. The cured composition can typically function as a structural bonding adhesive between the substrates or different portions of the same substrate.

Structural adhesives have been used previously for bonding together two surfaces such as the outer surfaces of two substrates. Structural bonding tapes, which include a curable structural adhesive composition, can be in the form of a roll or a die-cut part. Both the roll and the die-cut part typically include a release liner positioned on one or both major surfaces of the curable composition. Often, when applied to a substrate, a first surface of the curable composition is attached to a first substrate using finger pressure. To expose the first surface of the curable composition, it may be necessary to remove a release liner. Then, a second substrate is brought into contact with a second surface of the curable composition. To expose the second surface of the curable composition, it may be necessary to remove a release liner. The curable composition can be activated for curing either before or after positioning the curable composition between the first and second substrates. The cured product is an article that includes the first substrate bonded to the second substrate through the cured structural adhesive (i.e., cured composition).

In general, epoxy-containing curable compositions can be activated either by heat or by exposure to ultraviolet and/or visible radiation. Curable compositions that are cured by exposure to ultraviolet and/or visible radiation usually do not require the application of heat, but the curing reaction may be accelerated with heat. From a processing standpoint, a process of making bonded articles without a heating step can be desirable because many substrates can melt or undergo damaged by exposure to heat.

Some known curable compositions that have been used to form structural adhesives have handling issues. That is, even when positioned on a release liner, the curable compositions are often soft and flowable. During the process of removing a piece from a roll and/or removing a release liner, the curable structural adhesive can be stretched and/or torn. Further, many curable structural adhesive compositions are so soft and stretchy that the compositions need to be chilled prior to die cutting.

Another handling problem with some known curable structural adhesive compositions are due to their flow characteristics. For example, there may be a significant amount of flow when the curable compositions are in the form of a roll and the roll is subjected to winding tensions or when stacked. If the curable compositions are die-cut pieces, flow can occur when the pieces are stacked. As a result, many known curable adhesive compositions in the form of rolls or die-cut pieces need cold storage or special packaging for dimensional stability.

Curable structural adhesive compositions are needed that can be handled easily without stretching or tearing and that do not require cold storage. To address these needs, core-sheath filaments are provided that include a curable structural bonding adhesive in the core. More specifically, the core-sheath filament includes 1) a core containing a curable composition that includes an epoxy resin and a photoactive generator and 2) a sheath surrounding the core.

The core-sheath filaments that are provided can contain the curable composition within the sheath so that its dimensions remain relatively constant. That is, the sheath material can be selected to reinforce the curable composition to retain its size and shape during shipping, handling, and dispensing. The sheath constrains the curable composition so that it does not ooze out of the filament even when wound into a roll. Additionally, the sheath can be selected to protect the curable composition from premature curing upon exposure to ultraviolet and/or visible radiation. That is, the sheath can be selected to minimize exposure to ultraviolet and/or visible radiation that would prematurely activate curing of the curable adhesive composition within the core.

Further, the core-sheath filament can be used to print a desired pattern or shape, thus removing the need to prepare die-cut pieces that need to be stored under conditions that do not distort their size and/or shape. Still further, the core-sheath filament removes the need for release liners that add additional costs and waste or that can cause deformation of the curable adhesive composition upon removal.

The core-sheath filaments can be used to advantageously deposit the curable adhesive composition in any location or amount necessary to bond two substrates or different portions of the same substrate together. The curing process can be designed to initiate the curing reaction with ultraviolet and/or visible radiation prior to or just after positioning the substrates to be bonded together adjacent to the curable composition. Since the curable composition is molten when deposited, no additional heating step is required, which may accelerate manufacturing speed.

The core-sheath filaments can be used for printing or dispensing a curable composition using fused filament fabrication (FFF). The material properties needed for FFF dispensing typically are significantly different that those required for hotmelt dispensing of a curable structural adhesive composition. For instance, in the case of traditional hotmelt dispensing, the curable composition is melted into a liquid inside a tank and pumped through a hose and nozzle. Thus, traditional hotmelt dispensing requires a low-melt viscosity curable composition, which is often quantified as a high melt flow index curable composition. If the viscosity is too high (or the melt flow index (MFI) is too low), the hotmelt curable composition cannot be effectively transported from the tank containing the fluid curable composition to the nozzle where is it dispensed. In contrast, FFF includes melting a filament within the nozzle at the point of dispensing and is not limited to low melt viscosity curable compositions (high melt flow curable compositions) that can be easily pumped. In fact, a high melt viscosity curable composition (a low melt flow index curable composition) can advantageously provide geometric stability to the curable composition after dispensing, which allows for precise and controlled placement of the curable composition on the substrate of interest. The curable composition typically does not spread excessively after being deposited (printed).

In addition, FFF suitable filaments typically require at least a certain minimum tensile strength so that large spools of filament can be continuously fed to the nozzle without breaking. The FFF filaments are usually spooled into level wound rolls. If a core-sheath filament is spooled into level wound rolls, the material nearest the core can be subjected to high compressive forces. Preferably, the core-sheath filament is resistant to permanent cross-sectional deformation (i.e., compression set) and self-adhesion (i.e., blocking during storage).

### Definitions

The terms “a”, “an”, and “the” are used interchangeably with “at least one” to mean one or more of the elements being described. The phrases “at least one of” and “comprises at least one of” followed by a list refers to any one of the items in the list and any combination of two or more items in the list.

The term “and/or” means either or both. For example, the expression X and/or Y means X, Y, or a combination thereof (both X and Y).

The term “curable” refers to a composition or component that can be cured. The terms “cured” and “cure” refer to joining polymer chains together by covalent chemical bonds, usually via crosslinking molecules or groups, to form a polymeric network. A cured polymeric network is generally characterized by insolubility, but it may be swellable in the presence of an appropriate solvent.

The term “curable component(s)” as used herein refers to the curable composition minus any inorganic material that may be present. As used herein, the curable components include, but are not limited to, the epoxy resin, film-forming resin, polyol, and the photoacid generator.

The term “curable composition” refers to a total reaction mixture that is subjected to curing. The curable composition includes the curable components and any optional inorganic materials. The curable composition often includes all the materials used to prepare the core-sheath filament articles except the sheath material.

As used herein, the terms “curable structural adhesives”, “curable structural adhesive compositions”, “curable composition”, and the like are used interchangeably. Likewise, the terms “cured structural adhesive”, “cured structural adhesive compositions”, “cured composition”, and the like are used interchangeably.

As used herein, the term “filament composition” refers to the curable composition plus the sheath. The term “blended filament composition” refers to the composition that is formed by melting and mixing the filament composition.

The term “thermoplastic” refers to a polymeric material that flows when heated sufficiently above its glass transition temperature and becomes solid when cooled.

As used herein, “core-sheath filament” refers to a composition in which a first material (i.e., the core) is surrounded by a second material (i.e., the sheath) and the core and sheath have a common longitudinal axis. While the core and the sheath are typically concentric, the cross-sectional shape of the core can be any desired shape such as a circle, oval, square, rectangle, triangle, or the like. The ends of the core may or may not be surrounded by the sheath. The core-sheath filament typically has an aspect ratio of length to longest cross-sectional distance of at least 50:1.

The terms “core-sheath filament” and “filament” are used interchangeably. That is, the term “filament” includes both the core and the sheath.

The sheath surrounds the core in the core-sheath filament. In this context, “surround” (or similar words such as “surrounding”) means that the sheath composition covers the entire perimeter (i.e., the cross-sectional perimeter) of the core for a major portion (e.g., at least 80 percent or more, at least 85 percent or more, at least 90 percent or more, or at least 95 percent or more) of the length (the long axis direction) of the filament. Surrounding is typically meant to imply that all but perhaps the very ends of the filament have the core covered completely by the sheath.

The term “non-tacky” refers to a material that passes a “Self-Adhesion Test”, in which the force required to peel the material apart from itself is at or less than a predetermined maximum threshold amount, without fracturing the material. The Self-Adhesion Test is described below and is typically performed on a sample of the sheath material to determine whether the sheath is non-tacky.

The term “melt flow index” or “MFI” refers to the amount of polymer that can be pushed through a die at a specified temperature using a specified weight. Melt flow index can be determined using ASTM D1238-13 at 190° C. and with a load (weight) of 2.16 kg. Some of the reported values for the melt flow index are available from vendors of the sheath material and others were measured by the applicants using Procedure A of the ASTM method. The vendor data was reported as having been determined using the same ASTM method as well as the same temperature and load.

The term “semi-solid” refers to a substance that is between a liquid and a solid and that is resistant to flow at room temperature (e.g., in a range of 20° C. to 25° C.) but that can flow at elevated temperatures. The semi-solid often is a self-supporting material that can be formed into a shaped mass. The semi-solid is often a waxy or viscoelastic composition. In some embodiments, the first part and/or the second part have a shear elastic modulus (G′) from 10⁴-10⁶ Pascals (Pa) at 25° C. when measured at 1 Hertz and 1 percent strain. In some embodiments, the first part, the second part, or both have a complex viscosity (η*) from 10³-2.5×10⁵ Pascal·seconds (Pa·s) at 25° C. when measured at 1 Hertz and 1 percent strain.

The term “macroscopically stable” means that there is no change to the average three-dimensional distribution of components with time. The term “macroscopic phase separation” refers to spontaneous partitioning of components of a composition into distinct three-dimensional regions with at least one dimension having an average length of 1 micrometer. Often macroscopic phase separation is visible to the naked eye.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

As used herein, any statement of a range includes the endpoint of the range and all suitable values within the range (e.g., 1 to 5 includes 1, 1.5, 2, 2.75, 3, 3.80, 4, 5, etc.).

### Core-Sheath Filaments

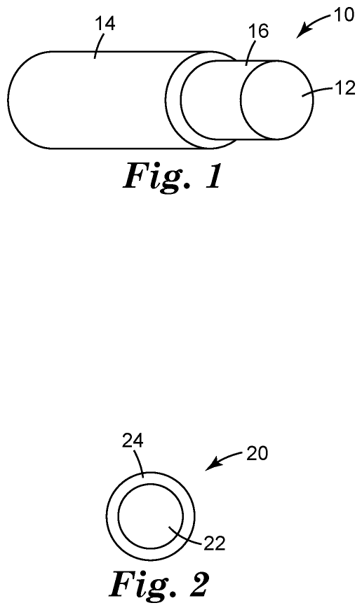

The core-sheath filaments are prepared by surrounding a non-tacky sheath around a core that includes a curable composition that contains 1) an epoxy resin and 2) a photoacid generator. An example core-sheath filament 10 is shown schematically in FIG. 1. The filament includes a core 12 and a sheath 14 surrounding (encasing) the outer surface 16 of the core 12. FIG. 2 shows the core-sheath filament 20 in a cross-sectional view. The core 22 is surrounded by the sheath 24. Any desired cross-sectional shape can be used for the core. For example, the cross-sectional shape can be a circle, oval, square, rectangular, triangular, or the like. The cross-sectional area of the core 22 is typically larger than the cross-sectional area of the sheath 24.

In addition to shape and area, the cross-section of the filament also includes cross-sectional distances. Cross-sectional distances are equivalent to the lengths of chords that could join points on the perimeter of the cross-section. The term “longest cross-sectional distance” refers to the greatest length of a chord that can be drawn through the cross-section of a filament, at a given location along its axis. The longest cross-sectional distance corresponds to the diameter for filaments that have a circular cross-sectional shape.

The core-sheath filament usually has a relatively small longest cross-sectional distance so that it can be used in applications where precise deposition of the curable composition is needed or is advantageous. For instance, the core-sheath filament usually has a longest cross-sectional distance in a range of 1 to 20 millimeters (mm). The longest cross-sectional distance of the filament can be at least 1 mm, at least 2 mm, at least 3 mm, at least 4 mm, at least 5 mm, at least 6 mm, at least 8 mm, or at least 10 mm and can be up to 20 mm, up to 18 mm, up to 15 mm, up to 12 mm, up to 10 mm, up to 8 mm, up to 6 mm, or up to 5 mm. This average distance can be, for example, in a range of 2 to 20 mm, 5 to 15 mm, or 8 to 12 mm.

Often, 0.5 to 10 percent of the longest cross-sectional distance (e.g., diameter) of the core-sheath filament is contributed by the sheath and 90 to 99.5 percent of the longest cross-sectional distance (e.g., diameter) of the core-sheath filament is contributed by the core. For example, up to 10 percent, up to 9 percent, up to 8 percent, up to 7 percent, up to 6 percent, up to 5 percent, up to 4 percent, up to 3 percent, or up to 2 percent and at least 0.5 percent, at least 1 percent, at least 2 percent, or at least 3 percent of the longest cross-sectional distance of the filament can be contributed by the sheath with the remainder being contributed by the core. The sheath extends completely around the perimeter (e.g., circumference, in the case of a circular cross-section) of the core so that the core does not stick to itself. In some embodiments, however, the ends of the filament may contain only the core.

Often, the core-sheath filament has an aspect ratio of length to longest cross-sectional distance (e.g., diameter) of 50:1 or greater, 100:1 or greater, or 250:1 or greater. Core-sheath filaments having a length of at least about 20 feet (6 meters) can be especially useful for printing a curable composition. Depending on the application or use of the core-sheath filament, having a relatively consistent longest cross-sectional distance (e.g., diameter) over its length can be desirable. For instance, an operator might calculate the amount of material being melted and dispensed based on the expected mass of filament per predetermined length; but if the mass per length varies widely, the amount of material dispensed may not match the calculated amount. In some embodiments, the core-sheath filament has a maximum variation of longest cross-sectional distance (e.g., diameter) of 20 percent over a length of 50 centimeters (cm), or even a maximum variation in longest cross-sectional distance (e.g., diameter) of 15 percent over a length of 50 cm.

Core-sheath filaments described herein can exhibit a variety of desirable properties, both as prepared and as a curable structural adhesive composition. As formed, a core-sheath filament desirably has strength consistent with being handled without fracturing or tearing of the sheath. The structural integrity needed for the core-sheath filament varies according to the specific application or use. Preferably, a core-sheath filament has strength consistent with the requirements and parameters of one or more additive manufacturing devices (e.g., 3D printing systems). One additive manufacturing apparatus, however, could subject the core-sheath filament to a greater force when feeding the filament to a deposition nozzle than a different apparatus. As formed, the core-sheath filament desirably also has modulus and yield stress consistent with being handled without excessive or unintentional stretching.

Advantageously, the elongation at break of the sheath material of the core-sheath filament is 50 percent or greater, 60 percent or greater, 80 percent or greater, 100 percent or greater, 250 percent or greater, 400 percent or greater, 750 percent or greater, 1000 percent or greater, 1400 percent or greater, or 1750 percent or greater and 2000 percent or less, 1500 percent or less, 900 percent or less, 500 percent or less, or 200 percent or less. Stated another way, the elongation at break of the sheath material of the core-sheath filament can range from 50 percent to 2000 percent. In some embodiments, the elongation at break is at least 60 percent, at least 80 percent, or at least 100 percent. Elongation at break can be measured, for example, by the methods outlined in ASTM D638-14, using test specimen Type IV.

Advantages provided by at least certain embodiments of employing the core-sheath filament to provide a curable composition once it is melted and mixed include one or more of: avoiding die-cutting, design flexibility, achieving intricate non-planar bonding patterns, printing on thin and/or delicate substrates, and printing on an irregular and/or complex topography.

Suitable components of the core-sheath filament are described in detail below.

### Core

The core contains a curable composition that includes an epoxy resin and a photoacid generator. Additionally, other optional components can be included in the core such as, for example, a film-forming resin, a polyol, and fillers. The core is typically a semi-solid that is sufficiently flexible so that the core-sheath filament can be rolled and/or directed into a nozzle for dispensing.

### Epoxy Resin

The epoxy resin that is included in the curable composition of the core has at least one epoxy functional group (i.e., oxirane group) per molecule. As used herein, the term oxirane group refers to the following divalent group.

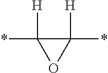

The asterisks denote a site of attachment of the oxirane group to another group. If the oxirane group is at the terminal position of the epoxy resin, the oxirane group is typically bonded to a hydrogen atom.

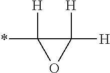

This terminal oxirane group is often (and preferably) part of a glycidyl group.

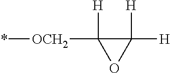

The epoxy resin often has at least one oxirane group per molecule and often has at least two oxirane groups per molecule. For example, the epoxy resin can have 1 to 10, 2 to 10, 2 to 6, 2 to 4, or 2 oxirane groups per molecule. The oxirane groups are usually part of a glycidyl group.

Epoxy resins can be either a single material or a mixture of different materials selected to provide the desired viscosity characteristics before curing and to provide the desired mechanical properties after curing. If the epoxy resin is a mixture of materials, at least one of the epoxy resins in the mixture is typically selected to have at least two oxirane groups per molecule. For example, a first epoxy resin in the mixture can have two to four oxirane groups and a second epoxy resin in the mixture can have one to four oxirane groups. In some of these examples, the first epoxy resin is a first glycidyl ether with two to four glycidyl groups and the second epoxy resin is a second glycidyl ether with one to four glycidyl groups. In another example, a first epoxy resin in the mixture is a liquid while a second epoxy resin is a solid such as a glassy or brittle solid that is miscible with the first epoxy resin.

The portion of the epoxy resin molecule that is not an oxirane group (i.e., the epoxy resin molecule minus the oxirane groups) can be aromatic, aliphatic or a combination thereof and can be linear, branched, cyclic, or a combination thereof. The aromatic and aliphatic portions of the epoxy resin can include heteroatoms or other groups that are not reactive with the oxirane groups. That is, the epoxy resin can include halo groups, oxy groups such as in an ether linkage group, carbonyl groups, carbonyloxy groups, and the like. The epoxy resin can also be a silicone-based material such as a polydiorganosiloxane-based material.

In most embodiments, the epoxy resin includes a glycidyl ether. Exemplary glycidyl ethers can be of Formula (I).

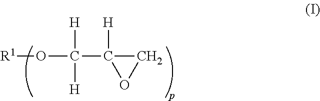

In Formula (I), group R¹ is a p-valent group that is aromatic, aliphatic, or a combination thereof. Group R¹ can be linear, branched, cyclic, or a combination thereof. Group R¹ can optionally include halo groups, oxy groups, carbonyl groups, carbonyloxy groups, and the like. Although the variable p can be any suitable integer greater than or equal to 1, p is often an integer in the range of 2 to 6 or 2 to 4. In many embodiments, p is equal to 2.

In some exemplary epoxy resins of Formula (I), the variable p is equal to 2 (i.e., the epoxy resin is a diglycidyl ether) and R¹ includes an alkylene (i.e., an alkylene is a divalent radical of an alkane and can be referred to as an alkane-diyl), heteroalkylene (i.e., a heteroalkylene is a divalent radical of a heteroalkane and can be referred to as a heteroalkane-diyl), arylene (i.e., a divalent radical of an arene compound), or mixture thereof. Suitable alkylene groups often have 1 to 20 carbon atoms, 1 to 12 carbon atoms, 1 to 8 carbon atoms, or 1 to 4 carbon atoms. Suitable heteroalkylene groups often have 2 to 50 carbon atoms, 2 to 40 carbon atoms, 2 to 30 carbon atoms, 2 to 20 carbon atoms, 2 to 10 carbon atoms, or 2 to 6 carbon atoms. The heteroatoms in the heteroalkylene are often oxy groups. Suitable arylene groups often have 6 to 18 carbon atoms, 6 to 12 carbon atoms, or 6 to 10 carbon atoms. For example, the arylene can be phenylene. Group R¹ can further optionally include halo groups, oxy groups, carbonyl groups, carbonyloxy groups, and the like.

Some epoxy resins of Formula (I) are diglycidyl ethers where R¹ includes (a) an arylene group or (b) an arylene group in combination with an alkylene, heteroalkylene, or both. Group R¹ can further include optional groups such as halo groups, oxy groups, carbonyl groups, carbonyloxy groups, and the like. These epoxy resins can be prepared, for example, by reacting an aromatic compound having at least two hydroxyl groups with an excess of epichlorohydrin. Examples of useful aromatic compounds having at least two hydroxyl groups include, but are not limited to, resorcinol, catechol, hydroquinone, p,p′-dihydroxydibenzyl, p,p′-dihydroxyphenylsulfone, p,p′-dihydroxybenzophenone, 2,2′-dihydroxyphenyl sulfone, and p,p′-dihydroxybenzophenone. Still other examples include the 2,2′, 2,3′, 2,4′, 3,3′, 3,4′, and 4,4′ isomers of dihydroxydiphenylmethane, dihydroxydiphenyldimethylmethane, dihydroxydiphenylethylme thylme thane, dihydroxydiphenylmethylpropylmethane, dihydroxydiphenylethylphenylmethane, dihydroxydiphenylpropylenphenylmethane, dihydroxydiphenylbutylphenylmethane, dihydroxydiphenyltolylethane, dihydroxydiphenyltolylmethylmethane, dihydroxydiphenyldicyclohexylmethane, and dihydroxydiphenylcyclohexane.

Some commercially available diglycidyl ether epoxy resins of Formula (I) are derived from bisphenol A (i.e., bisphenol A is 4,4′-dihydroxydiphenylmethane). Examples include, but are not limited to, those available under the trade designation EPON (e.g., EPON 828, EPON 872, EPON 1001F, EPON 1004, and EPON 2004) from Hexion Specialty Chemicals, Inc. in Houston, Tex., those available under the trade designation DER (e.g., DER 331, DER 332, and DER 336) from Dow Chemical Company (Midland, Mich., USA), and those available under the trade designation EPICLON (e.g., EPICLON 850) from Dainippon Ink and Chemicals, Inc. in Chiba, Japan. Other commercially available diglycidyl ether epoxy resins are derived from bisphenol F (i.e., bisphenol F is 2,2′-dihydroxydiphenylmethane). Examples include, but are not limited to, those available under the trade designation DER (e.g., DER 334) from Dow Chemical Company and those available under the trade designation EPICLON (e.g., EPICLON 830) from Dainippon Ink and Chemicals, Inc.

Other epoxy resins of Formula (I) are diglycidyl ethers of a poly(alkylene oxide) diol. These epoxy resins can be referred to as diglycidyl ethers of a poly(alkylene glycol) diol. The variable p is equal to 2 and R⁴ is a heteroalkylene having oxygen heteroatoms. The poly(alkylene glycol) can be a copolymer or homopolymer. Examples include, but are not limited to, diglycidyl esters of poly(ethylene oxide) diol, diglycidyl esters of poly(propylene oxide) diol, and diglycidyl esters of poly(tetramethylene oxide) diol. Epoxy resins of this type are commercially available from Polysciences, Inc. (Warrington, Pa., USA) such as those derived from a poly(ethylene oxide) diol or from a poly(propylene oxide) diol having a weight average molecular weight of about 400 Daltons, about 600 Daltons, or about 1000 Daltons. Other aliphatic epoxy resins of this type are commercially available from Nagase & Co., LTD (Osaka, Japan) under the trade designation DENACOL (e.g., DENACOL Ex-830).

Still other epoxy resins of Formula (I) are diglycidyl ethers of an alkane diol (R′ is an alkylene and the variable p is equal to 2). Examples include a diglycidyl ether of 1,4-dimethanol cylcohexyl, diglycidyl ether of 1,4-butanediol, and diglycidyl ethers of the cycloaliphatic diol formed from a hydrogenated bisphenol A such as those commercially available under the trade designation EPONEX 1510 from Hexion Specialty Chemicals, Inc. (Houston, Tex., USA).

Yet other epoxy resins include silicone resins with at least two glycidyl groups and flame retardant epoxy resins with at least two glycidyl groups (e.g., a brominated bisphenol-type epoxy resin having with at least two glycidyl groups such as that commercially available from Dow Chemical Company (Midland, Mich., USA) under the trade designation DER 580).

The epoxy resin is often a mixture of materials. For example, the epoxy resins can be selected to be a mixture that provides the desired viscosity or flow characteristics prior to curing. The mixture can include at least one first epoxy resin that is referred to as a reactive diluent that has a lower viscosity and at least one second epoxy resin that has a higher viscosity. The reactive diluent tends to lower the viscosity of the epoxy resin mixture and often has either a branched backbone that is saturated or a cyclic backbone that is saturated or unsaturated. Examples include, but are not limited to, the diglycidyl ether of resorcinol, the diglycidyl ether of cyclohexane dimethanol, the diglycidyl ether of neopentyl glycol, and the triglycidyl ether of trimethylolpropane. Diglycidyl ethers of cyclohexane dimethanol are commercially available under the trade designation HELOXY MODIFIER 107 from Hexion Specialty Chemicals (Columbus, Ohio, USA) and under the trade designation EPODIL 757 from Evonik Corporation (Essen, North Rhine-Westphalia, Germany). Other reactive diluents have only one functional group (i.e., oxirane group) such as various monoglycidyl ethers. Some exemplary monoglycidyl ethers include, but are not limited to, alkyl glycidyl ethers with an alkyl group having 1 to 20 carbon atoms, 1 to 12 carbon atoms, 1 to 8 carbon atoms, or 1 to 4 carbon atoms. Some exemplary monoglycidyl ethers are commercially available under the trade designation EPODIL from Evonik Corporation such as EPODIL 746 (2-ethylhexyl glycidyl ether) and EPODIL 748 (aliphatic glycidyl ether).

The epoxy resins in the core often have an equivalent weight in a range of 50 to 750 grams/equivalent. The equivalent weight of the epoxy resin refers to the weight of resin in grams that contains one equivalent of epoxy. The equivalent weight is often no greater than 750 grams/equivalent, no greater than 700 grams/equivalent, no greater than 650 grams/equivalent, no greater than 600 grams/equivalent, no greater than 550 grams/equivalent, no greater than 500 grams/equivalent, no greater than 450 grams/equivalent, no greater than 400 grams/equivalent, no greater than 350 grams/equivalent, no greater than 300 grams/equivalent, or no great than 250 grams/equivalent and is often at least 50 grams/equivalent, at least 75 grams/equivalent, at least 100 grams/equivalent, at least 125 grams/equivalent, or at least 150 grams/equivalent. In some embodiments, the equivalent weight is often in a range of 50 to 750 grams/equivalent, 50 to 500 grams/equivalent, 100 to 500 grams/equivalent, 100 to 300 grams/equivalent, or 150 to 250 grams/equivalent.

In many embodiments, 100 weight percent of the epoxy resin is of Formula (I). In other embodiments, at least 95 weight percent, at least 90 weight percent, at least 85 weight percent, at least 80 weight percent, at least 75 weight percent, or at least 70 weight percent of the epoxy resin is of Formula (I).

In many embodiment, 100 weight percent of the epoxy resin is a diglycidyl ether (i.e., a compound of Formula (I) with p equal to 2). In other embodiments, the epoxy resin is a mixture of compounds of Formula (I) with p equal to 2 and compounds of Formula (I) with p not equal to 2. In such mixtures, the amount of the diglycidyl ether is often at least 50 weight percent, at least 60 weight percent, at least 70 weight percent, at least 75 weight percent, at least 80 weight percent, at least 85 weight percent, at least 90 weight percent, or at least 95 weight percent based on the total weight of the epoxy resin.

In most embodiments, the epoxy resin is free of compounds that have an oxirane group that is not a glycidyl group. If such compounds are included, however, they typically make up less than 30 weight percent, less than 20 weight percent, less than 10 weight percent, less than 5 weight percent, less than 2 weight percent, less than 1 weight percent, or less than 0.5 weight percent based on the total weight of the epoxy resin.

The core contains at least 30 to 99.99 weight percent epoxy resin based on a total weight of the curable components. If the core contains less than 30 weight percent epoxy resin, there may be an insufficient amount of the epoxy resin to result in the formation of a cured composition with a suitable overlap shear strength. The amount of the epoxy resin can be at least 30 weight percent, at least 35 weight percent, at least 40 weight percent, at least 45 weight percent, at least 50 weight percent, at least 60 weight percent, or at least 70 weight percent and can be up to 99.99 weight percent, up to 99.9 weight percent, up to 99 weight percent, up to 95 weight percent, up to 90 weight percent, up to 80 weight percent, up to 70 weight percent, up to 60 weight percent, or up to 50 weight percent based on a total weight of the curable components in the curable composition.

### Photoacid Generator

The photoacid generator functions to initiate curing of the curable composition when exposed to ultraviolet and/or visible radiation. In some embodiments, the photoacid generator is activated at wavelengths less than 380 nanometers in the ultraviolet region of the electromagnetic spectrum. That is, the photoacid generator is usually selected to be sensitive to (activated by) radiation in the ultraviolet region of the electromagnetic spectrum but not to be sensitive to radiation in the visible or near ultraviolet region of the electromagnetic spectrum. The photoacid generator is often referred to as a cationic photoinitiator.

Some photoacid generators are iodonium salts. Example iodonium salts include, but are not limited to, bis(4-tert-butylphenyl) iodonium hexafluoroantimonate (available under the trade designation FP5034 from Hampford Research Inc. (Stratford, Conn., USA)), bis(4-tert-butylphenyl) iodonium camphorsulfonate, bis(4-tert-butylphenyl) iodonium hexafluorophosphate, bis(4-tert-butylphenyl) iodonium tetraphenylborate, bis(4-tert-butylphenyl) iodonium tosylate, bis(4-tert-butylphenyl) iodonium triflate, (4-methoxyphenyl)phenyl iodonium triflate, bis(4-methylphenyl) iodonium hexafluorophosphate (available under the trade designation OMNICAT 440 from IGM Resins (Bartlett, Ill., USA)), ([4-(octyloxy)phenyl]phenyl iodonium hexafluorophosphate), ([4-(octyloxy)phenyllphenyl iodonium hexafluoroantimonate), (4-isopropylphenyl)(4-methylphenyl) iodonium tetrakis(pentafluorophenyl) borate (available under the trade designation BLUESIL PI 2074 from Elkem Silicones (Lyon, France)), and 4-(2-hydroxy-1-tetradecycloxy)phenyl]phenyl iodonium hexafluoroantimonate.

Other photo-acid generators are often a triaryl sulfonium salt. Example triaryl sulfonium salts include, but are not limited to, triphenyl sulfonium hexafluoroantimonate, diphenyl(4-phenylthio)phenyl sulfonium hexafluorophosphate, diphenyl(4-phenylthio)phenyl sulfonium hexafluoroantimonate, bis(4-(diphenylsulfonio)phenyl)sulfide bis(hexafluorophosphate), and bis(4-(diphenylsulfonio)phenyl)sulfide hexafluoroantimonate. Blends of triaryl sulfonium salts are available from Synasia (Metuchen, N.J., USA) under the trade designation SYNA PI-6992 for hexafluorophosphate salts and under the trade designation SYNA PI-6976 for hexafluoroantimonate salts. Mixtures of triaryl sulfonium salts are commercially available from Aceto Pharma Corporation (Port Washington, N.Y., USA) under the trade designations UVI-6992 and UVI-6976.

The photo-acid generator is typically used in an amount of at least 0.01 weight percent and up to 5 weight percent based on the weight of the curable components in the curable composition. In some embodiments, the amount is at least 0.02 weight percent, at least 0.05 weight percent, at least 0.1 weight percent, at least 0.2 weight percent, at least 0.5 weight percent, at least 1 weight percent, or at least 2 weight percent and up to 5 weight percent, up to 4 weight percent, up to 3 weight percent, up to 2 weight percent, or up to 1 weight percent.

The core is typically free of both heat-activated curatives and thermal acid generators for epoxy resins. Examples of such heat activated curatives include, but are not limited to, dicyandiamide (DICY). Examples of thermal acid generators include, but are not limited to, products available under the trade designations NACURE, TAG, and K-PURE from King Industries (Norwalk, Conn., USA).

### Optional Polyol

The curable composition can optionally include a polyol. The polyol is typically a polymeric material and is often a polyether polyol, polyester polyol, (meth)acrylate-based polyol, or a polycaprolactam polyol.

The polyols can function as a toughening agent and/or can retard the curing reaction of the curable composition. As a toughening agent, the presence of the polyol can increase the shear strength of the final cured composition. That is, the polyols can decrease the crosslink density and increase the elongation of the cured composition. Additionally, some polyols such as polyether polyols tend to increase the “open time” of the curable composition. As used herein, the term “open time” refers to the time after the curable composition has exposed to ultraviolet and/or visible radiation, during which the curable composition remains sufficiently uncured for bonding to another surface.

The open time of the curable composition is desirably at least 2 minutes after exposure to ultraviolet and/or visible radiation. In some embodiments, UV-A radiation is provided by LED lights with an energy dose of 6 to 9 J/cm². If one or both substrates that are being bonded together are transmissive for the radiation to which the curable composition is exposed, however, the open time is of no relevance because in that case the exposure to the radiation can be effected through the transmitting substrate after both substrates have been attached to each other through the blended filament composition. When both substrates of the assembly are opaque, the blended filament composition is often exposed to ultraviolet radiation prior to attaching the second substrate thereto. In this case, an open time of at least two minutes may be desirable to allow for suitable workability within the partially cured composition.

In many embodiments, the polyol is a polyether polyol having at least two or at least 3 hydroxyl groups. The polyether polyols are typically polyether diols such as polyoxyalkylene glycols. Some example polyoxyalkyene glycols include, but are not limited to, polyoxyethylene glycols, polyoxypropylene glycols, and polyoxybutylene glycols (which can also be referred to as poly(tetramethylene oxide) glycols or poly(tetrahydrofuran) glycol). Other suitable polyether polyols are polyether triols such as polyoxyalkylene triols. These triols can be derived from glycerol. Examples include, but are not limited to, polyoxyetheylene triol and polyoxypropylene triol. The polyether polyol is typically miscible with or forms a macroscopically stable mixture with the other curable components such as the epoxy resin and any optional film-forming resin.

Suitable polytetramethylene oxide glycols include, for example, those commercially available under the trade designation POLYMEG from LyondellBasell, Inc. (Jackson, Tenn., USA), under the trade designation TERATHANE from Invista (Newark, Del., USA), and under the trade designation POLYTHF from BASF Corp. (Charlotte, N.C., USA). Suitable polyoxypropylene polyols include those commercially available under the trade designation ARCOL from Bayer Material Science (Los Angeles, Calif., USA).

Still other polyether polyols are commercially available under the trade designation VORANOL from Dow Chemical Company (Midland, Mich., USA) and under the trade designation DESMOPHEN from Covestro (Leverkusen, Germany) such as DESMOPHEN 550U, 1600U, 1900U, and 1950U. Additional polyether polyols are available under the trade designation CARBOWAX from Dow Chemical Company.

Suitable polyester polyols are commercially available under the trade designation DESMOPHEN from Covestro (Leverkusen, Germany) such as DEMMOPHEN 631A, 650A, 651A, 670A, 680, 110, and 1150. Other polyester polyols that are available under the trade designation DYNAPOL from Evonik Corporation (Essen, North Rhine-Westphalia, Germany) that can be linear and saturated, semi-crystalline or amorphous.

Suitable (meth)acrylate-based polyols are commercially available under the trade designation DESMOPHEN from Covestro (Leverkusen, Germany) such as DESMOPHEN A160SN, A575, and A450BA/A.

Suitable polycaprolactone polyols are commercially available from Dow Chemical Company (Midland, Mich., USA) under the trade designation TONE and from Ingevity (North Charleston, S.C., USA) under the trade designation CAPA.

The polyols can be characterized by their hydroxyl number, which refers to milligrams of KOH per gram of hydroxyl-containing material. This can be determined, for example, by adding an excess of an acidic material that reacts with the polyol and then by back titrating the remaining acidic material with a base to determine the amount of hydroxyl groups per gram of the polyol. The amount of hydroxyl groups is reported as though they were from the basic material KOH. The hydroxyl number (mg KOH per gram of polyol) is usually at least 10, at least 25, at least 50, at least 75, at least 100, at least 125, at least 150, at least 175, or at least 200 and can be up to 700, up to 650, up to 600, up to 550, up to 500, up to 450, up to 400, up to 350, up to 300, or up to 250.

In some embodiments, the polyol is a liquid at room temperature. In other embodiments, the polyether polyol is a liquid at temperatures above 40° C. The polyols that are not liquids at room temperature are often soluble in the other curable components or can be dissolved, if necessary, in an optional organic solvent. The weight average molecular weight can be up to 50,000 Daltons, up to 40,000 Daltons, up to 20,000 Daltons, up to 10,000 Daltons, or up to 5,000 Daltons. For example, the weight average molecular weight is often at least 100 Daltons, at least 500 Daltons, at least 750 Daltons, at least 1,000 Daltons, at least 1,500 Daltons, or at least 2,000 Daltons. In some embodiments, the polyether polyol has a weight average molecular weight in a range of 100 to 50,000 Daltons.

In many embodiments, the curable composition contains at least 1 weight percent of the polyol based on the total weight of the curable components in the curable composition. If there is too little polyol, the curable composition may cure (polymerize) too rapidly and there may be insufficient open time after activation of the photoacid generator and positioning a second substrate adjacent to the activated curable composition. That is, the structural strength of the bond between the first substrate and the second substrate (or different portion of the first substrate) may be compromised. Further, if there is not enough polyol, the toughness of the cured composition may not be adequate. The amount of the polyol can be in a range of 0 to 30 weight percent based on the total weight of curable components in the curable composition. If the amount of the polyol is too great, however, it may phase separate, the curable composition may not be a semi-solid, and the cured composition may have inadequate strength.

In many embodiments, the amount of the optional polyol is at least 1 weight percent, at least 2 weight percent, at least 3 weight percent, at least 4 weight percent, or at least 5 weight percent based on a total weight of the curable components in the curable composition. The amount the polyether polyol is often up to 30 weight percent, up to 25 weight percent, up to 20 weight percent, up to 18 weight percent, up to 15 weight percent, up to 12 weight percent, or up to 10 weight percent based on a total weight of the curable components. In some embodiments, the curable composition contains 0 to 30 weight percent, 1 to 30 weight percent, 1 to 25 weight percent, 1 to 20 weight percent, 1 to 15 weight percent, 2 to 25 weight percent, 2 to 20 weight percent, 2 to 15 weight percent, 4 to 25 weight percent, 4 to 20 weight percent, 4 to 15 weight percent, 5 to 25 weight percent, 5 to 20 weight percent, 5 to 15 weight percent, 8 to 25 weight percent, 8 to 20 weight percent, 8 to 15 weight percent, 10 to 25 weight percent, 10 to 20 weight percent, or 10 to 15 weight percent.

The weight ratio of the epoxy resin to the polyol is typically in a range of 0.5:1 to 10:1. Stated differently, the amount of epoxy resin can vary from being half of the amount of the polyol to 10 times the amount of the polyether polyol. In some embodiments, the weight ratio is at least 0.6:1, at least 0.8:1, at least 1:1, at least 1.5:1 at least 2:1, or at least 3:1 and can be up to 8:1, up to 6:1, up to 5:1, up to 4.5:1 or up to 4:1. In some embodiments, the weight ratio is in a range of 0.6:1 to 10:1, 0.8 to 10:1, 1:1 to 10:1, 1:1 to 8:1, 1:1 to 6:1, 1.5:1 to 6:1, 1.5:1 to 5:1, 1.5:1 to 4.5:1, 2:1 to 6:1, or 3:1 to 5:1.

### Optional Film-Forming Resin

The core can optionally further include a film-forming resin. The film-forming resin is typically selected to be miscible with the epoxy resin. To be miscible means that a mixture of the film-forming resin and the epoxy resin do not macroscopically phase separate from each other (i.e., the mixture is macroscopically stable).

To avoid macroscopic phase separation from the epoxy resin, the film-forming resin typically has polar groups such as, for example, carbonyloxy groups (—(CO)—O—), hydroxy groups (—OH), or ether groups (i.e., groups of formula —CH₂—O—CH₂—).

Suitable exemplary film-forming resins include, for example, (meth)acrylate copolymers such as those having pendant hydroxy groups and/or pendant ether groups (e.g., linear or cyclic ether group), ethylene vinyl acetate resins, phenoxy resins, and polyester resins. As used herein, the term “film-forming resins” does not include polyols that are described above.

The amount of the optional film-forming resin that can be added to the core is determined by such considerations as the required shear strength of the resulting structural adhesive composition and the viscosity of the core. The amount of the film-forming resin is often a range of 0 to 70 weight percent based on a total weight of curable components in the curable composition. The film-forming resin tends to increase the viscosity of the curable composition. If in addition to the film-forming resin, the curable components further include other optional polymeric material such as a polyol that tends to decrease the viscosity of the curable composition, then up to 70 weight percent of the curable components can be the film-forming polymer. On the other hand, if the curable components do not include another optional polymeric material that lowers viscosity, then up to 50 weight percent of the curable components can be the film-forming polymer. The upper limit may decrease further if fillers are added to the curable composition. The amount of the film-forming resin, if present, can be up to 70 weight percent, up to 60 weight percent, up to 50 weight percent, up to 40 weight percent, up to 30 weight percent, or up to 20 weight percent and at least 1 weight percent, at least 5 weight percent, at least 10 weight percent, at least 15 weight percent, or at least 20 weight percent based on the total weight of curable components in the curable composition. In some embodiments, the core does not include or is substantially free (e.g., less than 1 weight percent, less than 0.5 weight percent, or less than 0.1 weight percent of the curable components) of the film-forming resin.

### (Meth)acrylate Copolymers as a Film Forming Resins

In some embodiments, the film-forming resin is a (meth)acrylate copolymer such as one having pendant hydroxy groups and/or pendant ether groups. The (meth)acrylate copolymers are often formed from a monomer mixture that includes a first monomer that is a (meth)acrylate monomer having a hydroxy or ether group (e.g., a cyclic ether group or a linear ether group) and a second monomer that is an alkyl (meth)acrylate.

The first monomer can be of Formula (II). These monomers have a cyclic ether group.

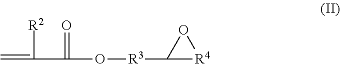

sIn Formula (II), group R² is hydrogen or methyl. Group R³ is a single bond, alkylene, a group of formula —(R⁵—O—R⁵)ₙ— where R⁵ is an alkylene and n is an integer in a range of 1 to 10. Group R⁴ is an alkylene. Suitable alkylene groups for R³, R⁴, and R⁵ typically contain 1 to 10, 1 to 8, 1 to 6, 1 to 4, or 1 to 3 carbon atoms. The variable n can be at integer of at least 1, at least 2, or at least 3 and up to 10, up to 8, up to 6, or up to 4. When R³ is a single bond, the cyclic ether group is bonded directly to CH₂═CR²—(CO)—O— as in 2-tetrahydropyrany acrylate.

Some specific examples of first monomers of Formula (II) include tetrahydrofurfuryl (meth)acrylate, glycidyl (meth)acrylate, 4-hydroxybutyl (meth)acrylate glycidyl ether, and 2-tetrahydropyranyl (meth)acrylate.

In other embodiments, the first monomer is of Formula (III). These monomers have a hydroxy or ether group (e.g, a linear ether group).

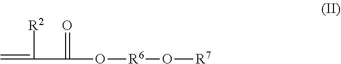

In Formula (III), group R² is hydrogen. Group R⁶ is an alkylene, arylene, or a group of formula —(R⁸—O—R⁸)ₘ— where R⁸ is an alkylene and m is in integer in a range of 1 to 10 or even greater. Group R⁷ is hydrogen, alkyl, or aryl. Suitable alkylene groups for R⁶ and R⁸ typically contain 1 to 10, 1 to 8, 1 to 6, 1 to 4, or 1 to 3 carbon atoms. Suitable arylene groups for R⁶ often contain 6 to 12, 6 to 10, or 6 carbon atoms (e.g., phenylene). Suitable alkyl groups for R⁷ often contain 1 to 10, 1 to 6, 1 to 4, or 1 to 3 carbon atoms. Suitable aryl groups for R⁷ often contain 6 to 12, 6 to 10, or 6 carbon atoms (e.g., phenyl). The variable m can be at integer of at least 1, at least 2, or at least 3 and up to 10, up to 8, up to 6, up to 4, up to 3, or up to 2. If R⁷ is hydrogen, the first monomer has a hydroxy group; if R⁷ is alkyl or aryl, the first monomer has an ether group.

Some specific examples of first monomers of Formula (III) include hydroxyalkyl (meth)acrylates such as hydroxyethyl (meth)acrylate, hydroxypropyl (meth)acrylate, and hydroxybutyl (meth)acrylate, poly(propylene glycol) (meth)acrylate, and poly(ethylene glycol) (meth)acrylate (which can be ethoxylated hydroxyethyl (meth)acrylates).

The amount of the first monomer is often in a range of 30 to 80 weight percent based on the total weight of monomers used to form the (meth)acrylate copolymer. For example, the amount of the first monomer can be at least 30 weight percent, at least 35 weight percent, at least 40 weight percent, at least 45 weight percent, at least 50 weight percent, at least 55 weight percent, or at least 60 weight percent and up to 80 weight percent, up to 75 weight percent, up to 70 weight percent, up to 65 weight percent, up to 60 weight percent, up to 55 weight percent, or up to 50 weight percent,

The (meth)acrylate copolymer that can be used as a film-forming resin typically is formed from a monomer mixture that further contains a second monomer that is an alkyl (meth)acrylate. Examples of alkyl (meth)acrylate that can be used as the second monomer include, but are not limited to, methyl (meth)acrylate, ethyl (meth)acrylate, n-propyl (meth)acrylate, isopropyl (meth)acrylate, n-butyl (meth)acrylate, isobutyl (meth)acrylate, n-pentyl (meth)acrylate, 2-methylbutyl (meth)acrylate, n-hexyl (meth)acrylate, cyclohexyl (meth)acrylate, 4-methyl-2-pentyl (meth)acrylate, 2-ethylhexyl (meth)acrylate, 2-methylhexyl (meth)acrylate, n-octyl (meth)acrylate, isooctyl (meth)acrylate, 2-octyl (meth)acrylate, isononyl (meth)acrylate, isoamyl (meth)acrylate, isobornyl (meth)acrylate, n-decyl (meth)acrylate, isodecyl (meth)acrylate, 2-propylheptyl (meth)acrylate, isotridecyl (meth)acrylate, isostearyl (meth)acrylate, octadecyl (meth)acrylate, 2-octyldecyl (meth)acrylate, dodecyl (meth)acrylate, lauryl (meth)acrylate, and heptadecanyl (meth)acrylates. In some embodiments, isomer mixtures of any of these monomers can be used. Monomers having an alkyl group with 1 to 8 carbon atoms may be preferred in some embodiments because the resulting (meth)acrylate copolymer may be more miscible with the epoxy resin.

The (meth)acrylate copolymer is often formed from a monomer mixture that contains 20 to 70 weight percent of the second monomer. The amount of the second monomer may be at least 20 weight percent, at least 25 weight percent, at least 30 weight percent, at least 35 weight percent, at least 40 weight percent, at least 45 weight percent, or at least 50 weight percent and up to 70 weight percent, up to 65 weight percent, up to 60 weight percent, up to 55 weight percent, or up to 50 weight percent based on a total weight of monomers used to form the (meth)acrylate copolymer.

For stability of the curable composition in the core, it is often preferable that the (meth)acrylate copolymer be prepared from a monomer mixture that is free or substantially free of acidic monomer, an amine-containing monomer, or a strongly basic monomer. Acidic monomers might prematurely initiate curing of the epoxy resin. That is, the curing reaction could commence prior to exposure of the curable composition to ultraviolet and/or visible radiation. For the same reason, it is usually preferable that the monomer mixture does not include amine-functional monomers, which refers to monomers having a —CH₂—NHR group with R is hydrogen or alkyl. On the other hand, basic monomers may inhibit cationic curing of the epoxy resin. Thus, the monomers often do not contain groups such as amide, lactam, urea, urethane, carboxylate, thiolate, sulfate, phosphate, or phosphine groups, and the like.

Various methods of making the (meth)acrylate copolymer are well known to those of skill in the art. Any suitable method can be used. The weight average molecular weight of the (meth)acrylate copolymer is often in a range of 50,000 to 1,000,000 Daltons.

### Ethylene-vinyl acetate Resins as a Film Forming Resin

In some embodiments, the film-forming resin is an ethylene-vinyl acetate (EVA) resin or similar polymers where a portion of the acetate groups have been converted by hydrolysis to hydroxy groups. The ethylene-vinyl acetate is typically a thermoplastic material.

Suitable ethylene-vinyl acetate copolymer resins often contain 28 to 90 weight percent (or even higher) vinyl acetate monomeric units based on a total weight of the EVA resin. For example, the EVA resin can contain at least 30 weight percent, at least 35 weight percent, at least 40 weight percent, at least 45 weight percent, at least 50 weight percent, at least 55 weight percent, or at least 60 weight percent and up to 90 weight percent (or even higher such as up to 95 weight percent or up to 99 weight percent), up to 85 weight percent, up to 80 weight percent, up to 75 weight percent, up to 70 weight percent, up to 65 weight percent, or up to 60 weight percent monomeric units of vinyl acetate. The EVA resin is often selected to contain 40 to 90 weight percent, 50 to 90 weight percent, or even 60 to 90 weight percent vinyl acetate monomeric units based on the total weight of the EVA resin.

Examples of commercially available ethylene-vinyl acetate copolymers that may be used include, but are not limited to, those available under the trade designation ELVAX from Dow Chemical Company (Midland, Mich., USA) such as ELVAX 150, 210, 250, 260, and 265, those available under the trade designation ATEVA series from Celanese, Inc. (Irving, Tex., USA), those available under the trade designation LEVAPREN from Arlanxeo USA (Pittsburgh, Pa., USA) such as LEVAPREN 400 with 40 weight percent vinyl acetate, LEVAPREN 450, 452, or 456 with 45 weight percent vinyl acetate, LEVAPREN 500 with 50 weight percent vinyl acetate, LEVAPREN 600 with 60 weight percent vinyl acetate, LEVAPREN 700 with 70 weight percent vinyl acetate, and LEVAPREN 800 with 80 weight percent vinyl acetate.

### Phenoxy Resins as a Film Forming Resin

In some embodiments, the film-forming resin is a phenoxy resin that has one or more hydroxy groups. Suitable phenoxy resins are often a thermoplastic material. The phenoxy resins are often derived from the polymerization of a di-glycidyl bisphenol compound. Typically, the phenoxy resin has a number average molecular weight in a range of 20,000 to 60,000 Daltons. For example, the number average molecular weight is at last 20,000 Daltons, at least 30,000 Daltons, at least 40,000 Daltons and up to 60,000 Daltons, up to 50,000 Daltons, up to 40,000 Daltons, or up to 30,000 Daltons.

Commercially available phenoxy resins suitable for use as film-forming resins include, but are not limited to, those available from Gabriel Performance Products (Akron, Ohio, USA) such as PKHP-200 and those available from Milliken Chemical (Spartanburg, S.C., USA) under the trade designation SYNFAC (e.g., SYNFAC 8009, 773240, 8024, 8027, 8026, 8071 and 8031). The SYNFAC materials are polyoxyalkylated bisphenol A resins.

### Polyester Resins as a Film Forming Resin

The film-forming resin can be a polyester resin such as semi-crystalline polyesters and amorphous polyesters. A material that is “amorphous” has a glass transition temperature but does not display a measurable crystalline melting point as determined using Differential Scanning calorimetry (DSC). Preferably, the glass transition temperature is less than about 100° C. A material that is “semi-crystalline” displays a crystalline melting point as determined by DSC, preferably with a maximum melting point of about 120° C. Suitable polyester resins are typically thermoplastic materials.

Crystallinity in a polymer can also be reflected by the clouding or opaqueness of a sheet that had been heated to an amorphous state as it cools. When the polyester polymer is heated to a molten state and knife-coated onto a liner to form a sheet, it is usually amorphous initially and the sheet is observed to be clear and transparent to light. As the polymer in the sheet material cools, crystalline domains can form, and the crystallization is characterized by the clouding of the sheet to a translucent or opaque state. The degree of crystallinity may be varied in the polymers by mixing in any compatible combination of amorphous polymers and semi-crystalline polymers having varying degrees of crystallinity. It is generally preferred that material heated to an amorphous state be allowed enough time to return to its semi-crystalline state before use or application. The clouding of the sheet provides a convenient non-destructive method of determining that crystallization has occurred to some degree in the polymer.

The polyesters may include nucleating agents to increase the rate of crystallization at a given temperature. Useful nucleating agents include microcrystalline waxes. A suitable wax could include an alcohol comprising a carbon chain having a length of greater than 14 carbon atoms (CAS #71770-71-5) or an ethylene homopolymer (CAS #9002-88-4) sold by Baker Hughes, Houston, Tex., as UNILIN 700.

The polyester resins are typically solid at room temperature. Suitable polyester resins often have a number average molecular weight of about 7,500 Daltons to 200,000 Daltons. In some examples, the polyester resins having a number average molecular weight of at least 10,000 Daltons, at least 15,000 Daltons, at least 20,000 Daltons, at least 25,000 Daltons, at least 30,000 Daltons, or at least 50,000 Daltons and up to 200,000 Daltons, up to 100,000 Daltons, up to 80,000 Daltons, up to 60,000 Daltons, up to 50,000 Daltons, up to 40,000 Daltons, and up to 30,000 Daltons.

Useful polyesters include the reaction product of dicarboxylic acids (or their diester equivalents) and diols. The diacids (or diester equivalents) can be saturated aliphatic acids containing from 4 to 12 carbon atoms (including branched, unbranched, or cyclic materials having 5 to 6 carbon atoms in a ring) and/or aromatic acids containing from 8 to 15 carbon atoms. Examples of suitable aliphatic acids are succinic, glutaric, adipic, pimelic, suberic, azelaic, sebacic, 1,12-dodecanedioic, 1,4-cyclohexanedicarboxylic, 1,3-cyclopentanedicarboxylic, 2-methylsuccinic, 2-methylpentanedioic, 3-methylhexanedioic acids, and the like. Suitable aromatic acids include terephthalic acid, isophthalic acid, phthalic acid, 4,4′-benzophenone dicarboxylic acid, 4,4′-diphenylmethanedicarboxylic acid, 4,4′-diphenylthioether dicarboxylic acid, and 4,4′-diphenylamine dicarboxylic acid. Often, the structure between the two carboxyl groups in the diacids contain only carbon and hydrogen atoms. Blends of the foregoing diacids may be used.

The diols used to prepare the polyesters can include branched, unbranched, and cyclic aliphatic diols having from 2 to 12 carbon atoms. Examples of suitable diols include ethylene glycol, 1,3-propylene glycol, 1,2-propylene glycol, 1,4-butanediol, 1,3-butanediol, 1,5-pentanediol, 2-methyl-2,4-pentanediol, 1,6-hexanediol, cyclobutane-1,3-di(2′-ethanol), cyclohexane-1,4-dimethanol, 1,10-decanediol, 1,12-dodecanediol, and neopentyl glycol. Long chain diols including poly(oxyalkylene)glycols in which the alkylene group contains from 2 to 9 carbon atoms, 2 to 6 carbon atoms, or 2 to 4 carbon atoms may also be used. Blends of the foregoing diols may be used.

In many embodiments, the polyester resin are hydroxyl-terminated polyesters that are semi-crystalline at room temperature. Useful, commercially available hydroxyl terminated polyester materials include various saturated linear, semi-crystalline polyesters available from Evonik Corporation (Essen, North Rhine-Westphalia, Germany) under the trade designation DYNAPOL such as DYNAPOL S1401, DYNAPOL S1402, DYNAPOL S1358, DYNAPOL S1359, DYNAPOL S1227, and DYNAPOL S1229. Useful saturated, linear amorphous polyesters available from Evonik Corporation include DYNAPOL 1313 and DYNAPOL S1430.

Additional useful polyester resins include polycaprolactone polyols available under the trade designation TONE from Dow Chemical Company (Midland, Mich., USA), polycaprolactone polyols available under the trade designation CAPA from Perstorp Inc. (Perstorp, Sweden), and saturated polyester polyols available under the trade designation DESMOPHEN (e.g., DESMOPHEN 631A 75) of from Covestro (Leverkusen, Germany).

### Optionalvinyl ethers

Like epoxy resins, some vinyl ethers can be cured upon activation of a photo-acid generator. These monomers can be used in place of some of the epoxy resins, if desired. In most embodiments, however, the curable components are free or substantially free of vinyl ethers. The term “substantially free” regarding the amount of vinyl ethers means that the curable components contains less than 1 weight percent, less than 0.5 weight percent, or less than 0.1 weight percent vinyl ether based on a total weight of the curable components.

In some embodiments where a vinyl ether is included in the curable components, the amount is no greater than 20 weight percent based on a total weight of the epoxy resin and vinyl ether. For example, the amount of vinyl ether is in a range of 1 to 20 weight percent, 1 to 15 weight percent, 1 to 10 weight percent, or 1 to 5 weight percent based on the total weight of epoxy resin and vinyl ether. To avoid inhibiting the cationic polymerization, the vinyl ether monomer may be limited to those not containing nitrogen. Examples of suitable vinyl ethers include, but are not limited to, methyl vinyl ether, ethyl vinyl ether, tert-butyl vinyl ether, isobutyl vinyl ether, triethylene glycol divinyl ether, and 1,4-cyclohexane dimethanol divinyl ether.

### Other Optional Components

In some curable compositions, an optional organic solvent is included. Suitable organic solvents include, but are not limited to, methanol, tetrahydrofuran, ethanol, isopropanol, pentane, hexane, heptane, acetone, methyl ethyl ketone, methyl acetate, ethyl acetate, toluene, xylene, ethylene glycol alkyl ether, propylene carbonate, and mixtures thereof. The organic solvent can be added to dissolve a reactant in the curable composition, can be added to lower the viscosity of the curable composition to facilitate its dispensing, or can be a residue from the preparation of the (meth)acrylate copolymer. The amount of organic solvent is controlled so that the curable composition is a semi-solid. The amount of the organic solvent in the curable composition can be in a range of 0 to 10 weight percent based on a total weight of the curable composition. In some embodiments, the amount is at least 0.5 weight percent, at least 1 weight percent, at least 2 weight percent, at least 3 weight percent, at least 4 weight percent and up to 10 weight percent, up to 9 weight percent, up to 8 weight percent, up to 7 weight percent, up to 6 weight percent, or up to 5 weight percent.

The curable composition optionally contains a flow control agent or thickener, to provide the desired rheological characteristics to the composition. Silica is a thixotropic agent and can be added to provide shear thinning Silica has the effect of lowering the viscosity of the curable composition when force (shear) is applied. When no force (shear) is applied, however, the viscosity seems higher. That is, the shear viscosity is lower than the resting viscosity. The silica typically has a longest average dimension that is less than 500 nanometers, less than 400 nanometers, less than 300 nanometers, less than 200 nanometers, or less than 100 nanometers. The silica particles often have a longest average dimension that is at least 5 nanometers, at least 10 nanometers, at least 20 nanometers, or at least 50 nanometers. In some embodiments, the silica particles are fumed silica such as treated fumed silica, available under the trade designation CAB-O-SIL TS 720, and untreated fumed silica available under the trade designation CAB-O-SIL M5, from Cabot Corporation (Alpharetta, Ga., USA). In other embodiments, the silica particles are non-aggregated nanoparticles.

If used, the amount of the optional silica particles is at least 0.5 weight percent based on a total weight of the curable composition. The amount of the silica can be at least 1 weight percent, at least 1.5 weight percent, or at least 2 weight percent and can be up to 10 weight percent, up to 8 weight percent, or up to 5 weight percent. For example, the amount of silica can be in a range of 0 to 10 weight percent, 0.5 to 10 weight percent, 1 to 10 weight percent, 0.5 to 8 weight percent, 1 to 8 weight percent, 0.5 to 5 weight percent, or 1 to 5 weight percent.

The curable composition can optionally include fibers for reinforcement of the cured composition. However, in many embodiments, the curable compositions are free or substantially free of fiber reinforcement. As used herein, “substantially free” means that the curable compositions contain no greater than 1 weight percent, no greater than 0.5 weight percent, no greater than 0.2 weight percent, no greater than 0.1 weight percent, no greater than 0.05 weight percent, or no greater than 0.01 weight percent of fibers.

In some embodiments, the curable composition optionally contains adhesion promoters to enhance the bond to the substrate. The specific type of adhesion promoter may vary depending upon the composition of the surface to which it will be adhered. Various silane and titanate compounds have been used to promote adhesion to the first substrate and/or the second substrate that are bonded together with the cured composition. If present, the amount of the adhesive promoter could be up to 5 weight percent, up to 3 weight percent, up to 2 weight percent, or up to 1 weight percent and at least 0.1 weight percent, at least 0.2 weight percent, or at least 0.5 weight percent based on the total weight of the curable composition.

Still other optional components include, for example, fillers (e.g., aluminum powder, carbon black, glass bubbles, talc, clay, calcium carbonate, barium sulfate, titanium dioxide, and mica), stabilizers, plasticizers, tackifiers, cure rate retarders, impact modifiers, toughening agents, expandable microspheres, glass beads or bubbles, thermally conductive particles, electrically conductive particles, fire retardants, antistatic materials, glass, pigments, colorants, and antioxidants. The optional components can be added, for example, to reduce the weight of the structural adhesive layer, to adjust the viscosity, to provide additional reinforcement, to modify the thermal or conductive properties, to alter the rate of curing, and the like. If any of these optional components are present, they are typically used in an amount that does not prevent the printing or dispensing of the curable composition.

### Overall Core Composition

The core contains the curable composition. The curable composition typically contains 30 to 99.99 weight percent epoxy resin, 0 to 70 weight percent film-forming resin, 0 to 30 weight percent polyol, and 0.01 to 5 weight percent photoacid generator based on a total weight of curable components within the curable composition. In some examples, the curable composition contains 30 to 98 weight percent epoxy resin, 1 to 70 weight percent film-forming resin, 1 to 30 weight percent polyol, and 0.05 to 5 weight percent photoacid generator based on a total weight of curable components within the curable composition. In other examples, the curable composition contains 30 to 70 weight percent epoxy resin, 10 to 60 weight percent film-forming resin, 0 to 20 weight percent polyol, and 0.1 to 5 weight percent photoacid generator based on a total weight of curable components within the curable composition. In yet other examples, the curable composition contains 30 to 70 weight percent epoxy resin, 20 to 60 weight percent film-forming resin, 1 to 20 weight percent polyol, and 0.1 to 5 weight percent photoacid generator based on a total weight of curable components within the curable composition. In still other examples, the curable composition contains 35 to 50 weight percent epoxy resin, 35 to 50 weight percent thermoplastic film-forming resin, 5 to 15 weight percent polyol, and 0.1 to 5 weight percent photoacid generator based on a total weight of curable components within the curable composition. Any of these core compositions can further include other optional components described above.

In some embodiments, the curable composition in the core it tacky. The term “tacky” as used in reference to the core means that the core feels tacky or sticky to the touch. Tackiness can be helpful for adhering the sheath to the core. If the core and sheath are co-extruded however, the need for a tacky core is diminished.

Overall, the curable composition is typically free or substantially free of strong acids or strong bases that would prematurely cure the curable composition prior to mixing with the sheath and being dispensed onto a substrate. Still further, the curable composition is typically free or substantially free of other “active hydrogen-containing compounds”. As used herein, other “active hydrogen-containing compounds” refers to compounds with amino and/or mercapto groups that can react with epoxy resins. As used herein regarding the presence of other active hydrogen containing compounds, the term “substantially free” means that the curable composition contains less than 0.5 weight percent, less than 0.2 weight percent, less than 0.1 weight percent, less than 0.05 weight percent, or less than 0.01 weight percent of other active hydrogen-containing compounds. The weight percent values are based on a total weight of the curable components in the curable composition.

### Sheath

The sheath provides structural integrity to the core-sheath filament and protects the curable composition in the core from premature curing. The sheath is typically selected to be thick enough to support the filament form factor and to allow delivery of the core-sheath filament to a deposition location. On the other hand, the thickness of the sheath is selected so that its presence does not adversely affect the overall structural adhesive performance of the cured composition.

The sheath material is typically selected to have a melt flow index (MFI) that is less than or equal to 15 grams/10 minutes when measured in accord with ASTM D1238-13 at 190° C. and with a load of 2.16 kilograms. Such a low melt flow index is indicative of a sheath material that has enough strength (robustness) to allow the core-sheath filament to withstand the physical manipulation required for handling, such as for use with an additive manufacturing apparatus. During such processes, the core-sheath filament often needs to be unwound from a spool, introduced into the additive manufacturing apparatus, and then advanced into a nozzle for melting and blending without breaking. Compared to sheath materials with a higher melt flow index, the sheath materials with a melt flow index that is less than or equal to 15 grams/10 minutes tend to be less prone to breakage (tensile stress fracture) and can be wound into a spool or roll having a relatively small radius of curvature. In certain embodiments, the sheath material exhibits a melt flow index of 14 grams/10 minutes or less, 13 grams/10 minutes or less, 11 grams/10 minutes or less, 10 grams/10 minutes or less, 8 grams/10 minutes or less, 7 grams/10 minutes or less, 6 grams/10 minutes or less, 5 grams/10 minutes or less, 4 grams/10 minutes or less, 3 grams/10 minutes or less, 2 grams/10 minutes or less, or 1 grams/10 minutes or less. If desired, various sheath materials can be blended (e.g., melted and mixed) together to provide a sheath composition having the desired melt flow index.

Low melt flow index values tend to correlate with high melt viscosities and high molecular weight. Use of higher molecular weight sheath material tends to result in better mechanical performance. That is, the sheath materials tend to be more robust (i.e., the sheath materials are tougher and less likely to undergo tensile stress fracture). This increased robustness is often the result of increased levels of polymer chain entanglements. The higher molecular weight sheath materials are often advantageous for additional reasons. For example, these sheath materials tend to migrate less to the adhesive/substrate interface in the final article; such migration can adversely affect the adhesive performance, especially under aging conditions. In some cases, however, block copolymers with relatively low molecular weights can behave like high molecular weight materials due to physical crosslinks. That is, the block copolymers can have low MFI values and good toughness despite their relatively low molecular weights.

The sheath materials are often semi-crystalline polymers that can provide robust mechanical properties even at relatively low molecular weight such as 100,000 Daltons. That is, sheath materials with a weight average molecular weight of at least 100,000 Daltons can often provide the toughness and elongation needed to form a stable filament spool. In many embodiments, the weight average molecular weight is at least 150,000 Daltons, at least 200,000 Daltons, at least 300,000 Daltons, at least 400,000 Daltons, or even at least 500,000 Daltons. The molecular weight can go up to 1,000,000 Daltons, up to 2,000,000 Daltons, or even higher. Higher molecular weight materials often advantageously have lower melt flow index values.

As the melt flow index is lowered (such as to less than or equal to 15 grams/10 minutes), less sheath material is required to obtain the desired mechanical strength. That is, the thickness of the sheath layer can be decreased and its contribution to the overall longest cross-sectional distance (e.g., diameter) of the core-sheath filament can be reduced. This is advantageous because the sheath material may adversely impact the adhesive properties of the final cured composition if it is present in an amount greater than about 10 weight percent of the total weight of the filament.

For application to a substrate, the core-sheath filament is typically melted and mixed together before deposition on the substrate. The sheath material desirably is blended with the curable composition in the core without adversely impacting the performance of the resulting cured composition, which is often a structural adhesive. To blend the two compositions effectively, it is often desirable that the sheath composition is compatible with the core composition. Because the core contains an epoxy resin with polar groups, the use of sheath materials that include polar groups such as oxy groups, carbonyl groups, or combinations thereof may be advantageous.

If the core-sheath filament is formed by co-extrusion of the core composition and the sheath composition, the melt viscosity of the sheath composition is desirably selected to be comparable to that of the core composition. If the melt viscosities are not sufficiently similar (such as if the melt viscosity of the core composition is significantly lower than that of the sheath composition), the sheath may not surround the core in the filament. The filament can then have exposed core regions. Additionally, if the melt viscosity of the sheath core composition is significantly higher than the core composition, during melt blending of the core composition and the sheath composition during dispensing, the non-tacky sheath may remain exposed (not blended sufficiently with the core) and adversely impact formation of an adhesive bond with the substrate. The melt viscosities of the sheath composition to the melt viscosity of the core composition is in a range of 100:1 to 1:100, in a range of 50:1 to 1:50, in a range of 20:1 to 1:20, in a range of 10:1 to 1:10, or in a range of 5:1 to 1:5. In many embodiments, the melt viscosity of the sheath composition is greater than that of the core composition. In such situations, the viscosity of the sheath composition to the core composition is typically in a range of 100:1 to 1:1, in a range of 50:1 to 1:1, in a range of 20:1 to 1:1, in a range of 10:1 to 1:1, or in a range of 5:1 to 1:1.

In addition to exhibiting strength, the sheath material is non-tacky. A material is non-tacky if it passes a “Self-Adhesion Test”, in which the force required to peel the material apart from itself without fracturing the material is no greater than a predetermined maximum threshold amount. The Self-Adhesion Test is described in the Examples below. Employing a non-tacky sheath allows the filament to be handled and optionally printed, without undesirably adhering to anything prior to deposition onto a substrate.

In certain embodiments, the sheath material exhibits a combination of low MFI (e.g., less than or equal to 15 grams/10 minutes) and moderate elongation at break (e.g., 100% or more as determined by ASTM D638-14 using test specimen Type IV) and low tensile stress at break (e.g., 10 MPa or more as determined by ASTM D638-14 using test specimen Type IV). A sheath having these properties tends to have the toughness suitable for use in FFF-type applications.

In some embodiments, to achieve the goals of providing structural integrity and a non-tacky surface, the sheath comprises a material selected from styrenic copolymers (e.g., styrenic block copolymers such as styrene-butadiene block copolymers), polyolefins (e.g., polyethylene, polypropylene, and copolymers thereof), ethylene vinyl acetates, polyurethanes, ethylene methyl acrylate copolymers, (meth)acrylic block copolymers, poly(lactic acids), and the like. Depending on the method of making the core-sheath filament, it may be advantageous to at least somewhat match the polarity of the sheath polymeric material with that of the core.

The sheath material is usually selected so that it is not miscible with the core at room temperature or under storage conditions for the core-sheath filament. It can be desirable, however, that the core and the sheath are miscible under molten conditions. Further, it is desirable that the sheath does not become tacky by being in contact with the core prior to use of the core-sheath filament.

Suitable styrenic materials for use in the sheath are commercially available and include, for example and without limitation, styrenic materials under the trade designation KRATON (e.g., KRATON D116 P, D1118, D1119, and A1535) from Kraton Performance Polymers (Houston, Tex., USA), under the trade designation SOLPRENE (e.g., SOLPRENE S-1205) from Dynasol (Houston, Tex., USA), under the trade designation QUINTAC from Zeon Chemicals (Louisville, Ky., USA), under the trade designations VECTOR and TAIPOL from TSRC Corporation (New Orleans, La., USA), and under the trade designations K-RESIN (e.g., K-RESIN DK11) from Ineos Styrolution (Aurora, Ill., USA).

Suitable polyolefins are not particularly limited and include, for example, polypropylene (e.g., a polypropylene homopolymer, a polypropylene copolymer, and/or blends comprising polypropylene) or polyethylene (e.g., a polyethylene homopolymer, a polyethylene copolymer, high density polyethylene (“HDPE”), medium density polyethylene (“MDPE”), low density polyethylene (“LDPE”), and combinations thereof). For instance, suitable commercially available LDPE resins include PETROTHENE NA217000 available from LyondellBasell (Rotterdam, Netherlands) with an MFI of 5.6 grams/10 minutes and MARLEX 1122 available from Chevron Phillips (The Woodlands, Tex., USA). Suitable HDPE resins include ELITE 5960G from Dow Chemical Company (Midland, Mich., USA) and HDPE HD 6706 series from ExxonMobil (Houston, Tex., USA). Polyolefin block copolymers are available from Dow Chemical Company under the trade designation INFUSE (e.g., INFUSE 9807).

Suitable commercially available thermoplastic polyurethanes include, for instance, ESTANE 58213 and ESTANE ALR 87A available from the Lubrizol Corporation (Wickliffe, Ohio, USA).

Suitable ethylene vinyl acetate (“EVA”) polymers (i.e., copolymers of ethylene with vinyl acetate) for use in the sheath include resins from Dow Chemical Company (Midland, Mich., USA) available under the trade designation ELVAX. Typical grades range in vinyl acetate content from 9 to 40 weight percent and a melt flow index of as low as 0.3 grams/10 minutes (per ASTM D1238-13). One exemplary material is ELVAX 3135 SB with an MFI of 0.4 grams/10 minutes. Suitable EVAs also include high vinyl acetate ethylene copolymers from LyondellBasell (Houston, Tex.) available under the trade designation ULTRATHENE. Typical grades range in vinyl acetate content from 12 to 18 weight percent. Suitable EVAs also include EVA copolymers from Celanese Corporation (Dallas, Tex.) available under the trade designation ATEVA. Typical grades range in vinyl acetate content from 2 to 26 weight percent.

Suitable poly(ethylene methyl acrylate) for use in the sheath include resins from Dow Chemical Company (Midland, Mich., USA) under the trade designation ELVALOY (e.g., ELVALOY 1330 with 30 percent methyl acrylate and an MFI of 3.0 grams/10 minutes, ELVALOY 1224 with 24 percent methyl acrylate and an MFI of 2.0 grams/10 minutes, and ELVALOY 1609 with 9 percent methyl acrylate and an MFI of 6.0 grams/10 minutes).

Suitable anhydride modified ethylene acrylate resins are available from Dow Chemical Company under the trade designation BYNEL such as BYNEL 21E533 with an MFI of 7.3 grams/10 minutes and BYNEL 30E753 with an MFI of 2.1 grams/10 minutes.

Suitable ethylene (meth)acrylic copolymers for use in the sheath include resins from Dow Chemical Company under the trade designation NUCREL (e.g., NUCREL 925 with an MFI of 25.0 grams/10 minutes and NUCREL 3990 with an MFI of 10.0 grams/10 minutes). The NUCREL 925 can be used if it is blended with another polymeric material such that the blend has lower MFI such as no greater than 15 grams/10 minutes.

Suitable (meth)acrylic block copolymers for use in the sheath include block copolymers from Kuraray (Chiyoda-ku, Tokyo, JP) under the trade designation KURARITY (e.g., KURARITY LA2250 and KURAITY LA4285). KURARITY LA2250, which has an MFI of 22.7 grams/10 minutes, is an ABA block copolymer with poly(methyl methacrylate) as the A blocks and poly(n-butyl acrylate) as the B block. About 30 weight percent of this polymer is poly(methyl methacrylate). The KURARITY LA2250 can be used in the sheath provided it is blended with another sheath material having a lower MFI such as, for example, KURARITY LA4285 so that the blend has an MFI that is no greater than 15 grams/10 minutes. KURARITY LA4285, which has an MFI of 1.8 grams/10 minutes, is an ABA block copolymer with poly(methyl methacrylate) as the A blocks and poly(n-butyl acrylate) as the B block. About 50 weight percent of this polymer is poly(methyl methacrylate). Varying the amount of poly(methyl methacrylate) in the block copolymer alters its glass transition temperature and its toughness.

Suitable poly(lactic acid) for use in the sheath include those available from Natureworks, LLC (Minnetonka, Minn., USA) under the trade designation INGEO (e.g., INGEO 4043D General Purpose Fiber grade).

In some embodiments, it may be desirable to add a UV blocker or colorant to the sheath composition. The UV blocker or colorant can protect the curable composition in the core from premature curing by UV radiation prior to deposition on the substrate. Suitable UV blockers include, but are not limited to, zinc oxide and titanium dioxide. Suitable colorants include carbon black. The amount of UV blocker or carbon black may need to be controlled because the presence of these materials may cause the temperature of the core-sheath filament to increase when exposed to UV radiation. If the temperature is increased too much, premature curing of the curable composition may occur. The amount of the UV blocker or carbon black is often in a range of 0 to 2 weight percent. For example, the amount may be 0 weight percent, at least 0.1 weight percent, at least 0.5 weight percent, or at least 1 weight percent and up to 2 weight percent, up to 1.5 weight percent, or up to 1 weight percent.

The sheath typically makes up 0.5 to 10 weight percent of the total weight of the core-sheath filament. The amount of the sheath is selected to provide a sufficiently robust core-sheath filament that can be easily handled without rupturing or tearing the sheath on the filament. The amount of the sheath material used in the core-sheath filament is often selected to be as low as possible because the sheath composition typically does not enhance (and can often diminish) the performance of the curable adhesive composition within the core. The amount of the sheath in the core-sheath filament can be at least 0.5 weight percent, at least 1 weight percent, at least 2 weight percent, at least 3 weight percent, at last 4 weight percent, at least 5 weight percent and up to 10 weight percent, up to 9 weight percent, up to 8 weight percent, up to 7 weight percent, up to 6 weight percent, or up to 5 weight percent based on the total weight of the core-sheath filament.

### Method of Printing and Bonding

In another aspect, a method of printing and bonding is provided. The method includes providing a core-sheath filament as described above. The method further includes melting the core-sheath filament and blending the sheath with the core to form a blended filament composition. Preferably, the sheath composition is uniformly blended with the core composition in the blended filament composition. The method still further includes dispensing the blended filament composition through a nozzle onto at least a first portion a first substrate. The method yet further includes positioning either a second substrate or a second portion of the first substrate in contact with the blended filament composition before or after exposing the blended filament composition to ultraviolet and/or visible radiation to activate curing of the curable composition. The method results in the formation of a structural adhesive bond between at least the first portion of the first substrate and either and the second substrate or the second portion of the first substrate.

One advantage of the method is that the filament composition can be dispensed onto the first substrate and the activation of the curing process can be delayed until the second substrate or a different portion of the first substrate is positioned in contact with the blended filament composition. The positioning of the second substrate or different portion of the first substrate may be later in the same manufacturing facility or in a second manufacturing facility days to weeks later. Covering the dispensed blended filament composition with an opaque release liner can protect it from curing and dust until the bond is ready to be activated and closed.

Fused Filament Fabrication, which is also known under the trade designation “FUSED DEPOSITION MODELING” from Stratasys, Inc., Eden Prairie, Minn., is a process that uses a thermoplastic strand fed through a hot can to produce a molten aliquot of material from an extrusion head. The extrusion head extrudes a bead of material in 3D space as called for by a plan or drawing (e.g., a computer aided drawing (CAD file)). The extrusion head typically lays down material in layers, and after the material is deposited, it fuses.

One suitable method for printing a core-sheath filament comprising a curable composition onto a substrate is a continuous non-pumped filament fed dispensing unit. In such a method, the dispensing throughput is regulated by a linear feed rate of the core-sheath filament allowed into the dispense head. In most currently commercially available FFF dispensing heads, an unheated filament is mechanically pushed into a heated zone, which provides adequate force to push the filament out of a nozzle. A variation of this approach is to incorporate a conveying screw in the heated zone, which acts to pull in a filament from a spool and to create pressure to dispense the material through a nozzle. Although addition of the conveying screw into the dispense head adds cost and complexity, it does allow for increased throughput, as well as the opportunity for a desired level of component mixing and/or blending. A characteristic of filament fed dispensing is that it is a true continuous method, with only a short segment of filament in the dispense head at any given point.

There can be several benefits to filament fed dispensing methods compared to traditional hot melt deposition methods. First, filament fed dispensing methods typically permits quicker changeover to different curable compositions. Also, these methods do not use a semi-batch mode with melting tanks, and this minimizes the opportunity for premature curing of the curable composition. Filament fed dispensing methods can use materials with higher melt viscosity, which can result in depositions having excellent geometric precision and stability. In addition, higher molecular weight raw materials as well as fillers can be used because of the higher allowable melt viscosity.

The form factor for FFF filaments is usually a concern. For instance, consistent cross-sectional shape and longest cross-sectional distance (e.g., diameter) assist in cross-compatibility of the core-sheath filaments with existing standardized FFF filaments such as ABS or polylactic acid (PLA). In addition, consistent longest cross-section distance (e.g., diameter) helps to ensure the proper throughput because the FFF dispense rate is generally determined by the feed rate of the linear length of a filament. Suitable longest cross-sectional distance variation of the core-sheath filament according to at least certain embodiments when used in FFF includes a maximum variation of 20 percent over a length of 50 cm, or even a maximum variation of 15 percent over a length of 50 cm.

Extrusion-based layered deposition systems (e.g., fused filament fabrication systems) are useful for making articles including printed curable composition in methods of the present disclosure. Deposition systems having various extrusion types of are commercially available, including single screw extruders, twin screw extruders, hot-end extruders (e.g., for filament feed systems), and direct drive hot-end extruders (e.g., for elastomeric filament feed systems). The deposition systems can also have different motion types for the deposition of a material, including using XYZ stages, gantry cranes, and robot arms. Common manufacturers of additive manufacturing deposition systems include Stratasys, Ultimaker, MakerBot, Airwolf, WASP, MarkForged, Prusa, Lulzbot, BigRep, Cosin Additive, and Cincinnati Incorporated. Suitable commercially available deposition systems include for instance and without limitation, BAAM, with a pellet fed screw extruder and a gantry style motion type, available from Cincinnati Incorporated (Harrison, Ohio); BETABRAM Model P1, with a pressurized paste extruder and a gantry style motion type, available from Interelab d.o.o. (Senovo, Slovenia); AM1, with either a pellet fed screw extruder or a gear driven filament extruder as well as a XYZ stages motion type, available from Cosine Additive Inc. (Houston, Tex.); KUKA robots, with robot arm motion type, available from KUKA (Sterling Heights, Mich.); and AXIOM, with a gear driven filament extruder and XYZ stages motion type, available from AirWolf 3D (Fountain Valley, Calif.).

Three-dimensional articles including a printed curable composition can be made, for example, from computer-aided design (CAD) models in a layer-by-layer manner by extruding a molten curable composition onto a substrate. Movement of the extrusion head with respect to the substrate onto which the curable composition is extruded is performed under computer control, in accordance with build data that represents the final article. The build data is obtained by initially slicing the CAD model of a three-dimensional article into multiple horizontally sliced layers. Then, for each sliced layer, the host computer generates a build path for depositing roads of the composition to form the three-dimensional article having a printed curable composition thereon. In select embodiments, the printed curable composition comprises at least one groove formed on a surface of the printed curable composition. Optionally, the printed curable composition forms a discontinuous pattern on the substrate.

The substrate onto which the molten curable composition is deposited is not particularly limited. In many embodiments, the substrate comprises a polymeric part, a glass part, or a metal part. Use of additive manufacturing to print a curable composition on a substrate may be especially advantageous when the substrate has a non-planar surface, for instance a substrate having an irregular or complex surface topography.

The core-sheath filament can be extruded through a nozzle carried by an extrusion head and deposited as a sequence of roads on a substrate in an x-y plane. The extruded molten curable composition fuses to previously deposited molten curable composition as it solidifies upon a drop-in temperature. This can provide at least a portion of the printed curable composition. The position of the extrusion head relative to the substrate is then incremented along a z-axis (perpendicular to the x-y plane), and the process is repeated to form at least a second layer of the molten curable composition on at least a portion of the first layer. Changing the position of the extrusion head relative to the deposited layers may be carried out, for example, by lowering the substrate onto which the layers are deposited. The process can be repeated as many times as necessary to form a three-dimensional article including a printed curable composition resembling the CAD model. Further details can be found, for example, Turner, B. N. et al., “A review of melt extrusion additive manufacturing processes: I. Process design and modeling”; Rapid Prototyping Journal 20/3 (2014) 192-204. In certain embodiments, the printed curable composition comprises an integral shape that varies in thickness in an axis normal to the substrate. This is particularly advantageous in instances where a shape of curable composition is desired that cannot be formed using die-cutting of a curable composition. In certain embodiments a single curable composition layer may be advantageous to minimize the amount of curable composition that is consumed or to minimize the thickness of the bond line.

A variety of fused filament fabrication 3D printers may be useful for carrying out the method according to the present disclosure. Many of these are commercially available under the trade designation “FDM” from Stratasys, Inc., Eden Prairie, Minn., and subsidiaries thereof. Desktop 3D printers for idea and design development and larger printers for direct digital manufacturing can be obtained from Stratasys and its subsidiaries, for example, under the trade designations “MAKERBOT REPLICATOR”, “UPRINT”, “MOJO”, “DIMENSION”, and “FORTUS”. Other 3D printers for fused filament fabrication are commercially available from, for example, 3D Systems, Rock Hill, S.C., and Airwolf 3D, Costa Mesa, Calif.

In certain embodiments, the method further comprises mixing the blended filament composition (e.g., mechanically) prior to dispensing the blended filament composition. In other embodiments, the process of being melted in and dispensed through the nozzle may provide sufficient mixing of the composition such that the blended filament composition is mixed in the nozzle, during dispensing through the nozzle, or both.

The temperature of the substrate onto which the curable composition can be deposited may also be adjusted to promote the fusing of the deposited curable composition. In the method according to the present disclosure, the temperature of the substrate may be, for example, at least about 100° C., 110° C., 120° C., 130° C., or 140° C. up to 175° C. or 150° C.

The dispensed curable composition is activated for curing by exposure with ultraviolet and/or visible radiation. Suitable LED light sources include for example and without limitation, Phoseon, 365 nm UV-LED Model FJ100 (available from Phoseon Technology Hillsboro, Oreg.). Suitable mercury light sources include for example, Light Hammer LHC10 Mark2 fusion lamp system (available from Heraeus Noblelight America LLC Gaithersburg, Maryland) equipped with a D-bulb. While many light sources are available, the duration of exposure is only restricted by the final dose in Joules/cm² received by the adhesive. For example, a LED source may have a power output of up to 40 W/cm², so only a few seconds of ultraviolet and/or visible radiation would be needed to achieve the desired dose of 6 to 9 J/cm². In some embodiments, the cured adhesive composition may be formed after less than 10 seconds exposure, less than 5 seconds exposure, or less than 2 seconds exposure to ultraviolet and/or visible radiation.

The blended filament composition is dispensed on at least a first portion of a first substrate. Either a second substrate or a second portion of the first substrate is positioned in contact with the blended filament composition either before or after exposing the blended filament composition to ultraviolet and/or visible radiation to activate curing of the curable composition. The method results in the formation of a structural adhesive bond between at least the first portion of the first substrate and either and the second substrate or the second portion of the first substrate.

The resulting bonded article can be useful in a variety of industries, for example, the apparel, architecture, business machines products, construction, consumer, defense, dental, electronics, educational institutions, heavy equipment, industrial, jewelry, medical, toys industries, and transportation (automotive, aerospace, and the like).

### EMBODIMENTS

Various embodiments are provided that include core-sheath filaments, methods of making the core-sheath filaments, and methods of printing and bonding with the core-sheath filaments. The curable compositions within the core-sheath filaments can function to form a structural adhesive bond between two substrates or different portions of the same substrate.

Embodiment 1A is a core-sheath filament comprising a core and a sheath. The core contains a curable composition that includes curable components containing 1) an epoxy resin and 2) a photoacid generator. The sheath surrounds the core and contains a thermoplastic material that is non-tacky.

Embodiment 2A is the core-sheath filament of embodiment 1A, wherein the core is a semi-solid.

Embodiment 3A is the core-sheath filament of embodiment 1A or 2A, wherein the curable components comprise 30 to 99.99 weight percent epoxy resin and 0.01 to 5 weight percent photoacid generator.

Embodiment 4A is the core-sheath filament of embodiment 1A or 3A, wherein the epoxy resin has an equivalent weight in a range of 50 to 750 grams/equivalent.

Embodiment 5A is the core-sheath filament of any one of embodiments 1A to 4A, wherein photoacid generator is an iodonium salt or a triaryl sulfonium salt.

Embodiment 6A is the core-sheath filament of any one of embodiments 1A to 5A, wherein the core optionally further comprises a film-forming resin.

Embodiment 7A is the core-sheath filament of embodiment 6A, wherein the film-forming resin is a thermoplastic material.

Embodiment 8A is the core-sheath filament of embodiment 7A, wherein the film-forming resin is ethylene vinyl acetate, a phenoxy resin, or a polyester resin.

Embodiment 9A is the core-sheath filament of embodiment 6A, wherein the film-forming resin is a (meth)acrylate copolymer having pendant hydroxy groups or pendant ether groups.

Embodiment 10A is the core-sheath filament of any one of embodiments 1A to 9A, wherein the curable components further comprise a polyol.

Embodiment 11A is the core-sheath filament of embodiment 10A, wherein the polyol is a polyether polyol.

Embodiment 12A is the core-sheath filament of any one of embodiments 1A to 11A, wherein the core comprising 30 to 99.99 weight percent epoxy resin, 0 to 30 weight percent polyol, 0 to 70 weight percent film-forming resin, and 0.01 to 5 weight percent photoacid generator based on a total weight of curable components within the curable composition.

Embodiment 13A is the core-sheath filament of any one of embodiments 1A to 12A, wherein the core comprises 30 to 70 weight percent epoxy resin, 10 to 60 weight percent film-forming resin, 0 to 20 weight percent polyol, and 0.05 to 5 weight percent photoacid generator based on a total weight of curable components within the curable composition.

Embodiment 14A is the core-sheath filament of any one of embodiments 1A to 13A, wherein the core comprises 30 to 70 weight percent epoxy resin, 10 to 60 weight percent film-forming resin, 1 to 20 weight percent polyol, and 0.1 to 5 weight percent photoacid generator based on a total weight of curable components within the curable composition.

Embodiment 15A is the core-sheath filament of any one of embodiments 1A to 14A, wherein the core comprises 35 to 50 weight percent epoxy resin, 35 to 50 weight percent thermoplastic film-forming resin, 5 to 15 weight percent polyol, and 0.1 to 5 weight percent photoacid generator based on a total weight of curable components within the curable composition.

Embodiment 16A is the core-sheath filament of any one of embodiments 1A to 15A, wherein the core-sheath filament comprises 90 to 99.5 weight percent core and 0.5 to 10 weight percent sheath based on the total weight of the core-sheath filament.

Embodiment 17A is the core-sheath filament of any one of embodiments 1A to 16A, wherein the core-sheath filament has a cross-sectional distance in a range of 1 to 20 millimeters.

Embodiment 18A is the core-sheath filament of any one of embodiments 1A to 17A, wherein the sheath exhibits a melt flow index of less than or equal to 15 grams per 10 minutes as determined using ASTM D1238-13 at 190° C. and with a load (weight) of 2.16 kg.

Embodiment 1B is a method of making a core-sheath filament. The method includes forming (or providing) a core that is curable composition containing curable components that include 1) an epoxy resin and 2) a photoacid generator. The method further includes providing a sheath that contains a non-tacky thermoplastic material. The method still further includes surrounding the core with the sheath to form the core sheath filament.

Embodiment 2B is the method of embodiment 1B, wherein surrounding the core with the sheath comprises co-extruding the core composition and the sheath composition.

Embodiment 3B is the method of embodiment 1B, wherein surrounding the core with the sheath comprises wrapping the sheath around the core.

Embodiment 4B is the method of any one of embodiments 1B to 3B, wherein the core-sheath filament is in accord with any one of embodiments 1A to 18A.

Embodiment 1C is a method of printing and bonding. The method includes providing a core-sheath filament as described in the first aspect above. The method further includes melting the core-sheath filament and blending the sheath with the core to form a blended filament composition. The method still further includes dispensing the blended filament composition through a nozzle onto at least a first portion a first substrate. The method yet further includes positioning either a second substrate or a second portion of the first substrate in contact with the blended filament composition before or after exposing the blended filament composition to ultraviolet and/or visible radiation to activate curing of the curable composition. The method yet further includes forming a structural adhesive bond between at least the first portion of the first substrate and either and the second substrate or the second portion of the first substrate.

Embodiment 2C is the method of embodiment 1C, wherein the core-sheath filament is in accord with anyone of embodiments 1A to 18A.

### EXAMPLES

Unless otherwise noted or readily apparent from the context, all parts, percentages, ratios, etc. in the Examples and the rest of the specification are by weight.

TABLE 1
Materials Used in the Examples

| Abbreviation | Description and Source |
|---|---|
| ARCOL | A polyether polyol, obtained under the trade designation |
| | “ARCOL LHT 240” from Covestro, LLC, |
| | Leverkusen, Germany |
| 6976 | A triarylsulfonium hexafluoroantimonate/propylene |
| | carbonate photoinitiator solution, obtained under |
| | the trade designation “CPI 6976” from |
| | Aceto Corporation, Port Washington, NY, USA |
| E-1001F | A diglycidylether of bisphenol-A epoxy resin, can |
| | be obtained under the trade designation “EPON 1001F” |
| | from Hexion Inc., Columbus, OH, USA |
| PEG-DGE | A diglycidylether of poly(ethylene glycol) with an |
| | average Mₙ of 500 and an epoxy equivalent weight |
| | of 264-290 grams/equivalent, obtained from |
| | MilliporeSigma, St. Louis, MS, USA |
| E-1510 | A hydrogenated epoxy resin having an epoxy equivalent |
| | weight of 210-220 grams/equivalent, can be obtained |
| | under the trade designation “EPONEX 1510” |
| | from Hexion Inc., Columbus, OH, USA |
| GPTMS | 3-(Glycidoxypropyl) trimethoxysilane, obtained from |
| | United Chemical Technologies, Inc., Bristol, PA, USA |
| PKHA | Phenoxy resin, obtained under the trade designation |
| | “PHENOXY PKHA” from Gabriel Performance |
| | Products, Akron, OH, USA |
| THFA | Tetrahydrofurfuryl acrylate, obtained under the trade |
| | designation “VISCOAT 150” from San Esters |
| | Corporation, New York, NY, USA |
| BDK | Benzyldimethyl ketal photoinitiator, obtained under |
| | the trade designation “OMNIRAD BDK” from |
| | IGM Resins USA Inc., Charlotte, NC, USA |
| IOTG | Isooctyl thioglycolate obtained from Evans Chemetics, |
| | LP, Teaneck, NJ, USA |
| BA | Butyl Acrylate, available from BASF Corporation, |
| | Florham Park, NJ, USA |
| EMA | A copolymer of ethylene and methyl acrylate, obtained |
| | under the trade designation “ELVALOY AC 1224” |
| | from Dow Chemical Company, Midland, MI, USA |
| PMMA | A 50:50 blend of PMMA-b-PnBA-b-PMMA A-B-A type |
| | block copolymers, obtained under the trade designations |
| | “KURARITY LA2250” and “KURARITY LA4285” |
| | from Kuraray, Chiyoda-ku, Tokyo, Japan |
| LVMLT | Ethylene-vinyl acetate copolymer, obtained under the |
| | trade designation “LEVAMELT 700” from |
| | Arlanxeo, Maastricht, Netherlands |
| EVA-CB | A pelletized ethyl vinyl acetate containing carbon |
| | black at a concentration of 40 wt %, obtained under |
| | the trade designation “REMAFIN BLACK EVA 40%” |
| | from Clariant Corporation, Holden, MA, USA |
| LDPE | Low density polyethylene, obtained under the trade |
| | designation “PETROTHENE NA217000” from |
| | Lyondell-Bassell, Houston, TX, USA |
| CRASTIN test | 30% glass-reinforced polybutylene terephthalate (PBT), |
| pieces | obtained under the trade designation “LW9030 BK851” |
| | from DuPont, Wilmington, DE, USA |
| Tempered glass | Clear tempered glass obtained from Industrial Glass |
| test pieces | Products, Los Angeles, CA, USA |

### Experimental Methods

### Method A. Extruded Core-Sheath Filament Preparation

Core-sheath filaments were prepared by coextrusion of the core material and the thermoplastic sheath material. The core formulation was fed through a Bonnot-feeder (The Bonnot Company, Akron, Ohio, USA). At the end of the Bonnot extruder, there was a 3 cc/rev melt pump (Colfax Corporation, Annapolis Junction, Md.) to achieve consistent flow. The non-tacky outer sheath was fed through a 19.1 mm single screw extruder (HAAKE, Thermo Fischer Scientific, Waltham, Mass., USA). Both melt streams were combined in an annular coextrusion die having approx. 3.50 mm diameter exit. The filament was drawn to approximately 10 mm final diameter through a water bath at room temp (approximately 22° C.).

### Method B. Sheath Formation

Films of non-tacky sheaths were prepared by hot melt pressing polymer resin pellets to average thickness of 5-9 mils (0.127-0.229 mm) in a Model 4389 hot press (Carver, Inc., Wabash, Ind., USA) at 140° C. Rectangles of film 1.5 inch (3.77 cm) in width and 2.7-5.9 inch (7-15 cm) in length were cut and used in the examples as described below.

### Method C. Preparation of Core/Sheath Curable Adhesive Filament

Core/sheath filaments were made by hand rolling 50-60 grams of adhesive into a cylinder 12 mm in diameter and surrounding the cylinder with enough non-tacky sheath rectangles to surround completely the tacky core.

### Method D. Filament Homogenization and Sheets

A 50 gram piece of core-sheath filament prepared by either Method A or Method C was fed into a BRABENDER mixer (C.W. Brabender Instruments, Inc., Hackensack, N.J., USA) equipped with a 50 gram capacity heated mixing bowl and kneading elements. The mixer was set at a temperature of 150° C. and the kneading elements were operated at 60 rpm. The material was blended for 5 minutes, then transferred to a siliconized release liner to cool. A 3-4 gram piece of homogenized material was placed between two release-coated polyethylene terephthalate liners (Loparex, Cary, N.C., USA). With 0.25 mm metal feeler gauges as spacers, the sample was pressed into a sheet at 140° C. with 5000 pounds for 20-60 seconds using a hydraulic lab press (Carver Inc., Wabash, Ind., USA). Care was taken to minimize ambient light exposure and to store samples in UV-opaque packaging.

### Method E. Perpendicular Torque Test Specimen Preparation

Test substrates (CRASTIN pieces measuring 22 mm×28 mm×4 mm and tempered glass plaques measuring 127 mm×50 mm×4 mm), were wiped using a Kimtech Science KIMWIPE (Kimberly-Clark Professional, Roswell, Ga.) sprayed with a 1:1 (v:v) isopropyl alcohol: water mixture. The substrates were then air-dried in ambient conditions. A 22 mm×28 mm piece of 0.25 mm caliper homogenized filament sheet was cut, one release liner removed, and the exposed adhesive surface was pressed smoothly onto the CRASTIN surface using light finger pressure. The second release liner was removed, and the CRASTIN/adhesive assembly was pressed onto the glass plaque with firm finger pressure. The closed bond assembly was placed under a 1″ diameter aluminum disc attached to the rod of a Model AP4 pneumatic air press (Air-Mite, Round Lake, Ill.) with electronic timer (GraLab Model 555, Centerville, Ohio). The bond assembly was pressurized for 6 s at an air inlet setting of 30 psi (0.21 MPa). Samples were then placed in a 90° C. oven for 6 min, re-pressurized as above, UV-activated through the glass substrate with 7 J/cm²/1 W/cm² UVA (as measured by a POWER PUCK II radiometer from EIT LLC, Leesburg, Va., USA) delivered from a 365 nm LED source (CLEARSTONE TECHNOLOGIES, Hopkins, Minn., USA), then replaced in the 90° C. oven for an additional 10 minutes. All samples were left to dwell/cure in ambient conditions for at least 24 hours prior to testing.

### Method F. Perpendicular Torque Testing

The adhesively bonded CRASTIN/glass assemblies were mounted vertically (i.e., with the plane of the bond in a vertical orientation) in an INSTRON Tensile Tester Model 5565 (INSTRON CORP, Canton, Mass.). An 80 mm lever arm was attached to the CRASTIN test piece, perpendicular to the plane of the bond and pulled upward at a rate of 50 mm per minute. The maximum value at break was recorded in Newtons (N).

### Method G. % UVA Transmitted

A 5.08 cm×7.62 cm glass slide (GS) was placed over the sensor of a POWER PUCK II radiometer (EIT LLC, Leesburg, Va., USA), which was then conveyed under a 365 nm LED light source (CLEARSTONE TECHNOLOGIES, Hopkins, Minn.). The resulting J/cm² UVA reading was recorded as entitlement UV transmission (T_{100%}). This was repeated five times and averaged. A 2.54 cm×2.54 cm piece of homogenized filament material between siliconized release liners (per Method D) was cut out. One release liner was removed, and the exposed sample surface was laminated to another GS. The other release liner was removed, the filament+GS assembly was placed over the radiometer sensor. The radiometer was again conveyed under the light source and the resulting J/cm² UVA reading was recorded as the UV transmitted through the filament material (T_{fill}). This was repeated twice for each material (with a new filament+GS assembly prepared for each measurement), and the values averaged. % UVA transmitted for each filament material was calculated as follows: (T_{fill}/T_{100%})×100.

### Method H. Self-Adhesion Test Method and Results

The Self-Adhesion Test was conducted on films of the sheath material to determine whether candidate sheath materials would meet the requirement of being “non-tacky”. Coupons (25 millimeters×75 millimeters×0.8 millimeters) were cut out. For each material two coupons were stacked on each other and placed on a flat surface within an oven. A 750 gram weight (43 millimeters diameter, flat bottom) was placed on top of the two coupons, with the weight centered over the films. The oven was heated to 50° C., and the samples were left at that condition for 4 hours, and then cooled to room temperature. A static T-peel test was used to evaluate pass/fail. The end of one coupon was fixed to an immobile frame, and a 250 gram weight was attached to the corresponding end of the other coupon with a binder clip. If the films were flexible and began to peel apart, they formed a T-shape. If the two coupons could be separated with the static 250 gram load within 3 minutes of applying the weight to the second coupon, it was considered a pass and was non-tacky. Otherwise, if the two coupons remained adhered, it was considered a fail.

The following sheath materials were evaluated and passed the Self-Adhesion Test: EMA, PMMA, and LDPE. Some of these materials are described more fully in the Detailed Description section above.

### Method I. Tensile Testing Polymer Dogbone for Strain Elongation at Break

Tensile testing was performed in accordance with “ASTM Standard D638-10: Standard Test Method for Tensile Properties of Plastics” using the following test parameters.
Specimen Type: Type IV dogbone (thickness shown in Table 3)
Test Apparatus: 100 kN MTS electromechanical load frame with pneumatic grips and ARAMIS digital image correlation system
Load Cell: 2.5 kN Load Capacity MTS
Crosshead Displacement (Nominal Strain Rate): 50 mm/min (1.5/min)
Pre-Test Conditioning: 23° C./50% Relative Humidity
Atmospheric Conditions During Testing: 22° C./39% Relative Humidity
Sample Size: A minimum of five test specimens were tested for each sample

Extensometer Description: ARAMIS 4M 3D Digital Image Correlation System with Titanar 2 mm camera lenses and ARAMIS Professional analysis software

### Method J. Melt Flow Index Test Method

Melt flow index (MFI) was conducted on all samples following the method set forth in ASTM D1238-13 (Standard Test Method for Melt Flow Rates of Thermoplastics by Extrusion 5 Platometer, latest revision in 2013), Procedure A. The equipment used was a Tinius Olsen MP 987 Extrusion Plastometer (Melt Indexer), with the standard die dimensions for Procedure A. Conditions for the test were a temperature of 190° C. and a weight of 2.16 kg. A total of 8-19 replicates were performed to determine statistics, namely average MFI (in units of g/10 minutes), standard deviation of the MFI, and the 95% confidence interval about the mean.

The MFI of a polymer blend can be approximated from the respective MFI's of the homopolymers using the following method:

log(MFI_{Final})=X1*log(MFI₁)+X2*log(MFI₂)

where X₁ and X2 are the weight fractions of each polymer Xᵢ and the MFI₁ and MFI2 are the melt flow indices of the virgin polymer. Below is a table for such calculations:

TABLE 2
Example Melt Flow Index Calculation for a Polymer Blend

| | | | MFI | MFI | | | Blend |
|---|---|---|---|---|---|---|---|
| Sheath | Polymer 1 | Polymer 2 | Polymer 1 | Polymer 2 | X₁ | X₂ | MFI |
| PMMA | LA2250 | LA4285 | 22.7 | 1.84 | 0.5 | 0.5 | 6.5 |

TABLE 3
Melt Flow Index Values for Sheath Materials

| | | MFI | Tensile | | Dogbone |
|---|---|---|---|---|---|
| | MFI | (grams/ | Elongation | Tensile | thickness |
| Sheath | Method | 10 min) | (%) | Method | (mm) |
| EMA | Literature | 2.0 | Not | — | — |
| | | | Tested | | |
| LDPE | Literature | 5.6 | 550 | Literature | 1.64 |
| | | | | Type IV | |
| | | | | specimen; | |
| | | | | ASTM D638-10 | |
| PMMA | Calculated | 6.5 | Not | — | — |
| | | | Tested | | |

### Preparative Example

### Preparative Structural Adhesive Core (PC-1) Compounding

A curable core was prepared by massing 17.8 parts by weight (pbw) PEG-DGE, 78.4 pbw E-1001F, 2.5 pbw GPTMS, and 1.3 pbw 6976 into a polypropylene MAX 200 DAC cup (FlackTek, Inc., Landrum, S.C.). The cup was loosely closed with a polypropylene lid and warmed to 100° C. to melt all components. After 2 hours at temperature, the mixture was high-shear mixed at ambient temperature and pressure using a FlakTek, Inc Speed Mixer (DAC 400 FVZ) for 2 minutes at 2750 rpm (revolutions per minute). Care was taken to minimize ambient light exposure of the finished sample.

### Preparative Structural Adhesive Core (PC-2) Compounding

A curable core was prepared by massing 42.6 parts by weight (pbw) E-1001F, 21.3 pbw E-1510, 16.8 pbw PKHA, 16.8 pbw ARCOL, 1.7 pbw GPTMS, and 0.8 pbw 6976 into a polypropylene MAX 200 DAC cup (FlackTek, Inc., Landrum, S.C., USA). The cup was loosely closed with a polypropylene lid and warmed to 100° C. to melt all components. After 3 hours at temperature, the mixture was high-shear mixed at ambient temperature and pressure using a FlakTek, Inc Speed Mixer (DAC 400 FVZ) for 2 minutes at 2750 rpm (revolutions per minute). Care was taken to minimize ambient light exposure of the finished sample.

### Preparative Acrylic Copolymer (PA-1)

An acrylic copolymer was prepared using the method of Hamer (U.S. Pat. No. 5,804,610). Solutions were prepared by combining 50 pbw each of BA and THFA acrylic monomers, 0.2 pbw BDK photoinitiator, and 0.1 pbw IOTG chain-transfer agent in an amber glass jar and swirling by hand to mix. The solution was divided into 25 g aliquots within heat-sealed compartments of an ethylene vinyl acetate-based film, immersed in a 16° C. water bath, and polymerized using UV light (UVA=4.7 mW/cm², 8 minutes per side).

### Preparative Structural Adhesive Core (PC-3) Compounding

To prepare this core, 32 pbw PA-1, 19 pbw E-1001F, 10 pbw LVMLT, 10 pbw PKHA, 19 pbw E-1510, 10 pbw ARCOL, 1 pbw GPTMS, and 0.5 pbw 6976 were compounded using a 30 mm Werner & Pfleiderer co-rotating twin screw extruder (Coperion GmbH, Stuttgart, DE). Components were premixed, then volumetrically fed into the extruder feed throat and subjected to 300 rotations per minute (rpm) mixing. The extruder, melt transport and die temperatures were set to 110° C. After compounding, the material was collected in silicone-coated boxes (Dura-Fibre, LLC, Menasha, Wis., USA). Care was taken to minimize ambient light exposure of the finished sample.

### Preparation of Non-Tacky Sheath 1 (S1)

Non-tacky S1 was prepared using Method B with EMA resin.

### Preparation of Non-Tacky Sheath 2 (S2)

Non-tacky S2 was prepared using 96 pbw EMA resin and 4 pbw EVA-CB and was co-extruded with the core using Method A.

### Preparation of Non-Tacky Sheath 3 (S3)

Non-tacky S3 was prepared using Method B with PMMA resin.

### Preparation of Core-Sheath Filament Material EX-1

Core-sheath filament material EX-1 was prepared for testing according to Methods B, C, and D using PC-1 for the core material and S1 for the sheath material.

### Preparation of Core-Sheath Filament Material EX-2

Core-sheath filament material EX-2 was prepared for testing according to Methods B, C, and D using PC-2 for the core material and S1 for the sheath material.

### Preparation of Core-Sheath Filament Material EX-3

Core-sheath filament material EX-3 was prepared for testing according to Methods A and D using PC-3 for the core material and S1 for the sheath material.

### Preparation of Core-Sheath Filament Material EX-4

Core-sheath filament material EX-4 was prepared for testing according to Methods A and D using PC-3 for the core material and S2 for the sheath material.

### Preparation of Core-Sheath Filament Material EX-5

Core-sheath filament material EX-5 was prepared for testing according to Methods B, C, and D using PC-3 for the core material and S3 for the sheath material.

Bonded test specimens were prepared according to Method E and tested according to Method F. % UVA transmitted was determined according to Method G.

TABLE 4
Core-Sheath Filament Examples

| | EX-1 | EX-2 | EX-3 | EX-4 | EX-5 |
|---|---|---|---|---|---|
| Core composition | PC-1 | PC-2 | PC-3 | PC-3 | PC-3 |
| Sheath composition | S1 | S1 | S1 | S2 | S3 |

Sheath components (pbw)

| | | | | | |
|---|---|---|---|---|---|
| LDPE | | | | | |
| EMA | 100 | 100 | 100 | 96 | |
| PMMA | | | | | 100 |
| EVA-CB | | | | 4 | |
| % UVA transmitted | | | 74 | 14 | |
| Perpendicular torque (N) | 41 | 109 | 22 | 37 | 135 |

1. A core-sheath filament comprising:
a) a core comprising a curable composition comprising curable components comprising
1) an epoxy resin; and
2) a photoacid generator;
b) a sheath surrounding the core, wherein the sheath comprises a thermoplastic material that is non-tacky.

2. The core-sheath filament of claim 1, wherein the curable components comprise 30 to 99.99 weight percent epoxy resin and 0.01 to 5 weight percent photoacid generator.

3. The core-sheath filament of claim 1, wherein the curable components further comprise a polyol.

4. The core-sheath filament of claim 1, wherein the curable components further comprise a film-forming resin.

5. The core-sheath filament of claim 4, wherein the film-forming resin comprises ethylene vinyl acetate, a phenoxy resin, a polyester resin, or (meth)acrylate copolymer having pendant hydroxy groups and/or pendant ether groups.

6. The core-sheath filament of claim 1, wherein the curable components comprise 30 to 99.99 weight percent epoxy resin, 0 to 30 weight percent polyol, 0 to 70 weight percent film-forming resin, and 0.01 to 5 weight percent photoacid generator based on a total weight of curable components within the curable composition.

7. The core-sheath filament of claim 1, wherein the core is a semi-solid.

8. The core-sheath filament of claim 1, wherein the core-sheath filament comprises 90 to 99.5 weight percent core and 0.5 to 10 weight percent sheath based on the total weight of the core-sheath filament.

9. The core-sheath filament of claim 1, wherein the core-sheath filament has a cross-sectional distance (e.g., diameter) in a range of 1 to 20 millimeters.

10. The core-sheath filament of claim 1, wherein the sheath exhibits a melt flow index of less than or equal to 15 grams per 10 minutes as determined using ASTM D1238-13 at 190° C. and with a load (weight) of 2.16 kg.

11. A method of making a core-sheath filament, the method comprising:
a) forming or providing a core comprising a curable composition comprising curable components comprising
1) an epoxy resin; and
2) a photoacid generator;
b) providing a sheath composition comprising a non-tacky thermoplastic material; and
c) surrounding the core with the sheath to form the core sheath filament.

12. A method of printing and bonding, the method comprising:
a) providing the core-sheath filament of claim 1;
b) melting the core-sheath filament and blending the sheath with the core to form a blended filament composition; and
c) dispensing the blended filament composition through a nozzle onto at least a first portion of a first substrate; and
d) positioning either a second substrate or a second portion of the first substrate in contact with the blended filament composition before or after exposing the blended filament composition to ultraviolet and/or visible radiation to activate curing of the curable composition; and
e) forming a structural adhesive bond between at least the first portion of the first substrate and either the second substrate or the second portion of the first substrate.
